(19) United States
(12) Patent Application Publication
(10) Pub. No.: US 2025/0269756 A1
(43) Pub. Date: Aug. 28, 2025

(54) SYSTEM AND METHODS FOR ELECTRIC VEHICLE CHARGING VIA A PUSH REMOTE PAYMENT TRANSACTION

(71) Applicant: Mastercard International Incorporated, Purchase, NY (US)

(72) Inventors: Nicolas Schmidt, San Francisco, CA (US); Abhijit Malvi, Highlands Ranch, CO (US); Maurice David Liscia, Long Island City, NY (US); Mohamed Abouelenin, San Carlos, CA (US)

(73) Assignee: Mastercard International Incorporated, Purchase, NY (US)

(21) Appl. No.: 19/056,509

(22) Filed: Feb. 18, 2025

Related U.S. Application Data
(60) Provisional application No. 63/556,777, filed on Feb. 22, 2024.
(60) Provisional application No. 63/557,143, filed on Feb. 23, 2024.
(60) Provisional application No. 63/719,863, filed on Nov. 13, 2024.

(51) Int. Cl. B60L 53/66; B60L 53/65; B60L 53/68

(52) U.S. Cl. CPC B60L 53/665; B60L 53/65; B60L 53/68; B60L 2240/70

(57) ABSTRACT

Techniques for enabling secure remote commerce (SRC) transactions for electric vehicle (EV) charging at a charge point (CP) are disclosed. The techniques include establishing a mutually authenticated and encrypted communication session between an EV user system and the CP using transport layer security (TLS). The EV receives merchant information, including a charge point identifier and charge point operator certificate details. The EV retrieves payment credentials from a digital wallet, including a digital card ID assigned by an SRC system. A cryptographically signed payload containing the digital card ID, merchant information, and a timestamp is generated and signed using a private key associated with the EV. The signed payload is transmitted securely to the SRC system via an application programming interface (API). Upon receiving an authorization response approving the payment transaction, the EV transmits a command to the CP to initiate charging.

### CROSS REFERENCE TO RELATED APPLICATIONS

The present application claims priority from U.S. Provisional Patent Application No. 63/556,777, filed Feb. 22, 2024, and titled SYSTEM AND METHODS FOR ELECTRIC VEHICLE CHARGING; U.S. Provisional Patent Application No. 63/557,143, filed Feb. 23, 2024, and titled SYSTEM AND METHODS FOR ELECTRIC VEHICLE CHARGING; and U.S. Provisional Patent Application No. 63/719,863, filed Nov. 13, 2024, and titled SYSTEM AND METHODS FOR ELECTRIC VEHICLE CHARGING. The entire disclosure, including any appendices, of each of the aforementioned priority applications is hereby incorporated by reference herein.

### FIELD OF THE DISCLOSURE

The field of the disclosure relates generally to systems and methods for charging an electric vehicle and, more particularly, to systems and methods for obtaining transaction information directly from the electric vehicle.

### BACKGROUND OF THE DISCLOSURE

In recent years, the number of disparate electric vehicle charging stations has increased. Each of the different charging stations may require the use of different applications in order to authorize charging of electric vehicles and exchange transaction information.

Recent standards, such as ISO 15118, define a vehicle-to-grid (V2G) communication interface for bi-directional charging and discharging of electric vehicles. Additionally, open loop payments may be provided over the V2G communication interface. When performing open loop payments, transaction information may be exchanged between an electric vehicle (EV) and a charging point (CP) over the same wire used to charge the EV. After the transaction information is exchanged, the CP provides a charging current to the EV Currently, charge point operators (CPOs) use varying, often incompatible, payment systems, preventing consumers from charging at certain charge points (CPs). Further, when the EV attempts to connect to a CP that is not compatible with a payment system currently used by the customer, the customer may be required to perform cumbersome steps required to register for a new payment system used by the CP and provide payment information to the new CP. Furthermore, data privacy concerns may arise when a customer is required to provide their payment information to a number of different CPOs.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computer-implemented method for enabling secure remote commerce (SRC) transactions for electric vehicle (EV) charging at a charge point (CP) is provided. The method includes establishing, by a user system of the EV, a mutually authenticated and encrypted communication session with the CP via a transport layer security (TLS) protocol. The method further includes receiving, by the user system, merchant information from the CP, wherein the merchant information includes a unique identifier (ID) of the CP and a charge point operator certificate issuer identifier. The method also includes retrieving, by the user system, payment credentials from a digital wallet stored in the EV, the payment credentials comprising a digital card ID assigned to the EV by an SRC system. Additionally, the method includes generating, by the user system, a cryptographically signed payload comprising the digital card ID, the merchant information, and a timestamp, wherein the signed payload is signed by the user system using a private key associated with the EV. The method includes transmitting, by the user system, the signed payload to the SRC system via an application programming interface (API) over a secure communication channel. The method further includes receiving, by the user system, an authorization response from the CP, wherein the authorization response indicates that the payment transaction is approved. In response to receiving the authorization approval, the method includes transmitting, by the user system, a command to the CP to initiate charging of the EV.

In another aspect, a computing system for enabling a secure remote commerce (SRC) transaction for charging an electric vehicle (EV) at a charging point (CP) is provided. The system includes one or more processors and a memory having computer-executable instructions stored thereon. When executed by the one or more processors, the instructions cause the processors to perform operations to facilitate the secure transaction. The one or more processors establish a mutually authenticated and encrypted communication session with the CP via a transport layer security (TLS) protocol. The one or more processors further receive merchant information from the CP, wherein the merchant information includes a unique identifier (ID) of the CP and a charge point operator certificate issuer identifier. The one or more processors retrieve payment credentials from a digital wallet stored in the EV, the payment credentials comprising a digital card ID assigned to the EV by an SRC system. The one or more processors also generate a cryptographically signed payload comprising the digital card ID, the merchant information, and a timestamp, wherein the signed payload is signed by the user system using a private key associated with the EV. The one or more processors transmit the signed payload to the SRC system via an application programming interface (API) over a secure communication channel. The one or more processors receive an authorization response from the CP, wherein the authorization response indicates that the payment transaction is approved. In response to receiving the authorization approval, the one or more processors transmit a command to the CP to initiate charging of the EV.

A variety of additional aspects will be set forth in the detailed description that follows. These aspects can relate to individual features and to combinations of features. The advantages of these and other aspects will be apparent to those skilled in the art from the following description of the exemplary embodiments which have been shown and described by way of illustration. As will be realized, the details of the present aspects described herein may be modified in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example vehicle charging payment network system;

FIG. 2 is an example configuration of an electric vehicle, such as the electric vehicle of the vehicle charging payment network system shown in FIG. 1;

FIG. 3 is an example configuration of a charge point operated by a charge point operator, such as the merchant of the vehicle charging payment network system shown in FIG. 1;

FIG. 4 is an example configuration of a user system, such as the user system shown in FIG. 1;

FIG. 5 is an example configuration of a server system, such as the server system shown in FIG. 1;

FIG. 6 is a process flow diagram for one embodiment of registering an electric vehicle with the vehicle charging payment network system shown in FIG. 1;

New FIG. 7 is a sequence diagram of a method for generating a contract and provisioning the contract to the electric vehicle of the vehicle charging payment network system shown in FIG. 1;

FIG. 8 is a process flow diagram for binding payment card information with a digital wallet of an electric vehicle utilizing the vehicle charging payment network system shown in FIG. 1;

FIG. 9 is a schematic diagram for one embodiment of the vehicle charging payment network system shown in FIG. 1, showing data flow among the parties during a payment transaction for charging an electric vehicle;

FIG. 10 is a schematic diagram for an alternative embodiment of the vehicle charging payment network system shown in FIG. 1, showing data flow among the parties during a payment transaction for charging an electric vehicle;

FIG. 11 is a schematic diagram for another alternative embodiment of the vehicle charging payment network system shown in FIG. 1, showing data flow among the parties during a payment transaction for charging an electric vehicle;

FIG. 12 is a process flow diagram of a process for transferring data and electrical power between an electric vehicle and a charge point;

FIGS. 13A and 13B are process flow diagrams of an alternative process for transferring data and electrical power between an electric vehicle and a charge point;

FIGS. 14A and 14B are process flow diagrams of another alternative process for transferring data and electrical power between an electric vehicle and a charge point;

FIGS. 15A and 15B are process flow diagrams of another alternative process for transferring data and electrical power between an electric vehicle and a charge point; and

FIG. 16 is a schematic diagram for another alternative embodiment of the vehicle charging payment network system shown in FIG. 1, showing data flow among the parties during a payment transaction for charging an electric vehicle.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to charging electric vehicles. The scope of the present invention is defined only by the appended claims, along with the full scope of equivalents to which such claims are entitled.

### Example Electric Vehicle Charging Payment System

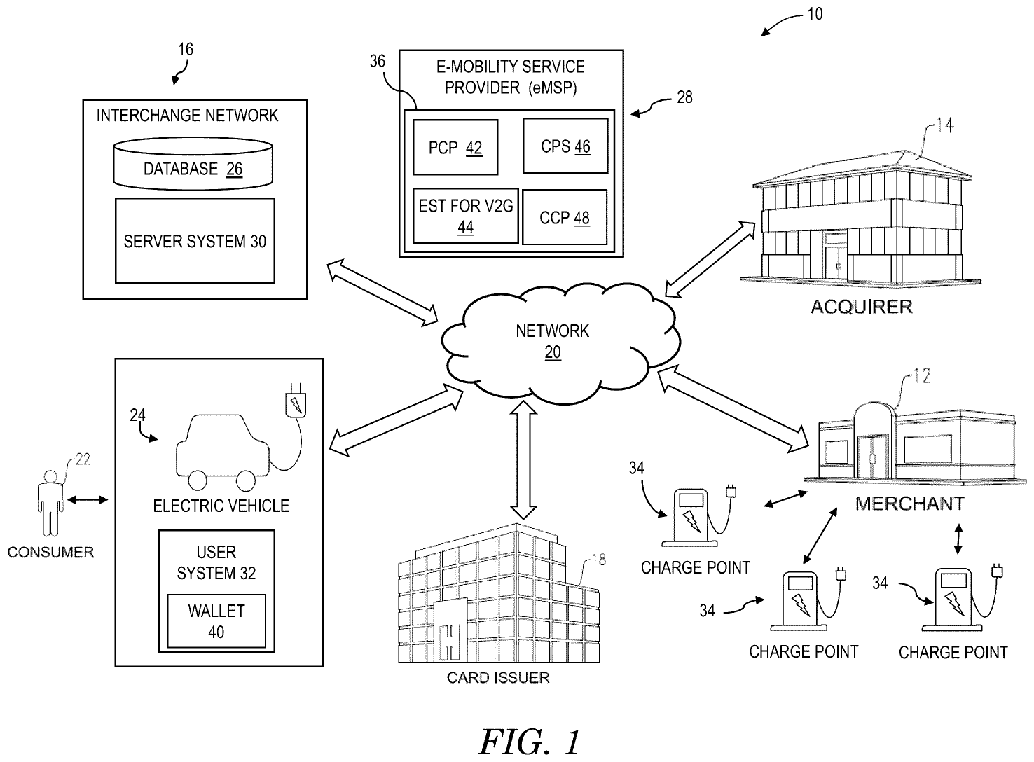

FIG. 1 is a block diagram of an example electric vehicle (EV) charging payment network system 10. In the exemplary embodiment, the system 10 facilitates providing interchange network services offered by an interchange network 16 (broadly, a “payment processor”). In addition, the system 10 enables payment card transactions in which merchants 12, acquirers 14, issuers 18, and/or e-mobility service providers (eMSPs) 28 do not need to have a one-to-one relationship. Although parts of the system 10 are presented in one arrangement, other embodiments may include the same or different parts arranged otherwise, depending, for example, on authorization processes for purchase transactions, communication between computing devices, etc.

As used herein, the phrase “payment card network” or “interchange network” includes a system or network used for the transfer of funds between two or more parties using cash-substitutes. Transactions performed via a payment card network may include, for example, goods and/or service purchases, credit purchases, debit transactions, fund transfers, account withdrawals, and the like. Payment card networks may be configured to perform such transactions using cash-substitutes including, for example, and without limitation, payment cards, checks, financial accounts, and the like. The phrases payment card network and/or interchange network may include the payment card network as an entity, and the physical payment card network, such as the equipment, hardware, and software making up the network.

In the example embodiment, the system 10 generally includes the merchant 12, the acquirer 14, the interchange network 16, the issuer 18, and the eMSP 28 coupled together in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchant 12, the acquirer 14, the interchange network 16, the eMSP 28, and/or the issuer 18. In some embodiments, the network 20 may include more than one type of network, such as a private payment transaction network provided by the interchange network 16 to the acquirer 14, the issuer 18 and the eMSP 28, and, separately, the public Internet, which may facilitate communication between the merchant 12, the interchange network 16, the acquirer 14, the eMSP 28, and consumers 22, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of the Mastercard interchange network. As used herein, “financial transaction data” includes both (1) a unique account number—such as a primary account number (PAN)—that is linked to an account holder or consumer 22 using a payment card issued by an issuer, and (2) purchase data reflecting the consumer's transaction. This purchase data may include details such as the merchant type, purchase amount, purchase date, and additional relevant information. Such data may be transmitted among any parties within the network system 10.

In a typical transaction card system, a financial institution (the “issuer”) issues a transaction card, such as a credit card, to a consumer, such as the consumer 22. The consumer 22 uses the transaction card to tender payment for a purchase from the merchant 12. The consumer 22 may input information from a transaction card (broadly, payment credentials) into a user system 32 and store the information in a digital wallet 40 as digital wallet data. The merchant 12 is typically associated with products, for example, and without limitation, goods and/or services, that are offered for sale and are sold to the consumer 22. In particular, the merchant 12 is associated with operating charge points (CPs) 34. The CPs 34 are configured to provide electrical energy to electric vehicles (EVs). The merchant 12 includes, for example, a physical location and/or a virtual location such as an Internet-based storefront.

To accept payment from the consumer 22 using, for example, the digital wallet data stored in the digital wallet 40, the merchant 12 must normally establish an account with a financial institution that is part of the system 10. This financial institution is usually called the “merchant bank,” the “acquiring bank,” or the acquirer 14. When the consumer 22 submits payment for a purchase with the user system 32 using the digital wallet 40, the merchant 12 requests authorization from the acquirer 14 for the purchase. The request may be performed over a telephone but is usually performed using a point-of-sale terminal that reads the consumer's account information from a magnetic stripe, a chip, embossed characters on the transaction card, or digital wallet data and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

The interchange network 16 and computers of the acquirer 14 or merchant processors will communicate with computers of the issuer 18 to determine whether the consumer's account is in good standing and whether the purchase is covered by the consumer's available credit line. Based on these determinations, the request for authorization will be declined or accepted. If the request is accepted, an authorization code is issued to the merchant 12.

When a request for authorization is accepted, the available credit line of the consumer's account is decreased. Normally, a charge for a payment card transaction is not posted immediately to the consumer's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the consumer 22 cancels a transaction before it is captured, a “void” is generated. If the consumer 22 returns goods after the transaction has been captured, a “credit” is generated. The interchange network 16 and/or the issuer 18 stores in a database, such as database 26, the payment card information, such as, and without limitation, a type of merchant, a merchant identifier, a location where the transaction was completed, an amount of purchase, and a date and time of the transaction.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, consumer account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

In some embodiments, the payment card transaction is a card present transaction conducted, for example, by swiping or dipping a payment card at the merchant's point-of-sale (POS) terminal. Alternatively, the payment card transaction may be a card-not-present transaction conducted, for example, with a payment card stored on file with the merchant or stored as digital wallet data in a digital wallet 40 on a consumer's computing device, such as the user system 32. In some embodiments, the user system 32 and digital wallet 40 may be integrated with the electric vehicle (EV) 24.

The user system 32 may be, for example, a computing device integrated with the EV 24, a cellular telephone, a smart watch or other electronic wearable apparel, a tablet, an implanted smart device, a personal computing device, or any other electronic device capable of two-way digital communications which may be associated with a consumer. In some embodiments, the user system 32 may be replaced with another computing device suitable for performing the functions disclosed herein (e.g., a desktop or laptop computer, a smart television, etc.).

In the exemplary embodiment, the user system 32 may also allow the consumer 22 to create an account with a server system 30 or with another component of the interchange network 16. During the account setup process, the consumer 22 may send account registration information to the server system 30 via the user system 32. The account registration information may include, for example, and without limitation, payment account data (e.g., the PAN, a virtual payment number, limited use number, etc.) and user system identification data (e.g., a provisioning certificate identifier (PCID), Electronic Serial Number (ESN), Mobile Equipment Identifier (MEID), International Mobile Equipment Identity (IMEI) number, and the like).

For instance, the server system 30 may receive account registration information from the user system 32 (identifying the user system 32) and a payment account or PAN associated with the consumer 22. The consumer 22 may, for example, set up the account with the server system 30 by providing the account registration information and generating a login identifier (i.e., a UserID) and a password used when logging into an application for communicating with the server system 30. The consumer 22 may transmit various information or data to the server system 30 via the application, which may be stored on, partially stored on, or accessed via a web-browser of the user device 32. The information or data transmitted by the user to the server system 30 may include, for example, and without limitation, authentication information associated with the consumer's PAN, biometrics of the consumer, and/or contact information. The contact information may include one or more ways to communicate with the consumer 22, including, for example, a push notification associated with the mobile application, a short messaging service (SMS) message, an email message, telephone number, and the like. The server system 30 may generate a new account profile or update an existing account profile for the account associated with the account registration information received from the user system 32. Payment information associated with the account is stored in the digital wallet 40.

In the example embodiment, the system 10 includes the server system 30, which may be part of the interchange network 16 (shown in FIG. 1). The server system 30 is coupled in communication with the CPs 34, the merchant 12, the acquirer 14, and the issuer 18. The server system 30 is also coupled in communication with a one or more client systems, also referred to as the user systems 32. In one embodiment, the user systems 32 are computers including a web browser, such that server system 30 is accessible to the user systems 32 using the Internet. The user systems 32 are interconnected to the Internet through one or more of many interfaces including, for example, a network, such as a LAN or WAN, dial-in-connections, cable modems, and/or special high-speed Integrated Services Digital Network (ISDN) lines. The user systems 32 could be any device capable of interconnecting to the Internet including an Internet connected phone, a PDA, or any other suitable web-based connectable equipment.

In the example embodiment, the system 10 includes the one or more CPs 34, which may be connected to the merchant 12 and to the server system 30. The CPs 34 may be interconnected to the Internet (or any other network that allows the CPs 34 to communicate as described herein) through many interfaces including a network, such as a local area network (LAN) or a wide area network (WAN), dial-in-connections, cable modems, wireless modems, and special high-speed ISDN lines. The CPs 34 are any device capable of interconnecting to the Internet and including an input device capable of reading information received from the digital wallet 40 of the user system 32. As used herein, the term charge point is used broadly and generally to refer to any device capable of charging an electric vehicle in which a consumer interacts with a merchant to complete a payment card transaction.

In the example embodiment, the server system 30 is connected to a database 26. The database 26 is configured to store information on a variety of matters, including account information associated with consumers. In one embodiment, the database 26 is a centralized database stored on the server system 30 and can be accessed by potential users at the user system 32 by logging onto the server system 30 through the user system 32. In an alternative embodiment, the database 26 is stored remotely from the server system 30 and may be a distributed or non-centralized database.

In one example embodiment, the database 26 may include a single database having separated sections or partitions or may include multiple databases, each being separate from each other. The database 26 may store transaction data generated as part of sales activities and savings activities conducted over the processing network including data relating to merchants, account holders or customers, issuers, acquirers, savings amounts, savings account information, and/or purchases made. The database 26 may also store account data including at least one of a consumer name, a consumer address, an account number, and other account identifiers. The database 26 may also store merchant data including a merchant identifier that identifies each merchant registered to use the network, and instructions for settling transactions including merchant bank account information. The database 26 may also store purchase data associated with items being purchased by a consumer from a merchant, and authorization request data. The database 26 may also store device information, payment card information, and other data involved with processing transactions between one or more parties.

In the example embodiment, the user system 32 may be associated with the consumer 22 and the EV 24. Alternatively, the user system 32 may be associated with the merchant 12, issuer 18, and/or the acquirer 14. The CP 34 may be associated with the merchant 12 (shown in FIG. 1). The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the user system 32 and the CP 34 may include a computer system associated with at least one of a merchant, an online bank, a bill payment outsourcer, an acquirer bank, an acquirer processor, an issuer bank associated with a payment card, an issuer processor, a remote payment processing system, and/or a biller. It is noted that the system 10 may include more, fewer, or alternative components and/or perform more, fewer, or alternative actions, including those discussed elsewhere herein.

In the exemplary embodiment, the eMSP 28 facilitates enabling the consumer 22 to access multiple CPs 34 (operated by different merchants 12, for example) without the need to have a membership or account with the specific CP 34 or merchant 12. For example, the eMSP 28 may streamline one or more services, such as billing, customer support, and network management. In some embodiments, the eMSP 28 may function as an “aggregator platform” for electric vehicle charging. That is, the eMSP 28 may facilitate interaction between EV drivers (i.e., the consumer 22) and various charging networks (i.e., CPs 34 and merchants 12), eliminating the need for separate memberships at each CP 34. As described further herein, the eMSP 28 provides payment contract services for the consumer 22 to enable secure plug-and-charge functionality. The eMSP 28 includes a computing system 36. The computing system 36 includes, for example, a provisioning certificate pool (PCP) module 42, an enrollment over secure transport (EST) for V2G module 44, a certificate provisioning service (CPS) module 46, and a contract certificate pool (CCP) module 48. These modules are collectively responsible for managing, signing, and distributing cryptographic credentials and contract data to enable secure, automated payment-based charging for electric vehicles (EVs), as described herein.

### Exemplary Computer Systems

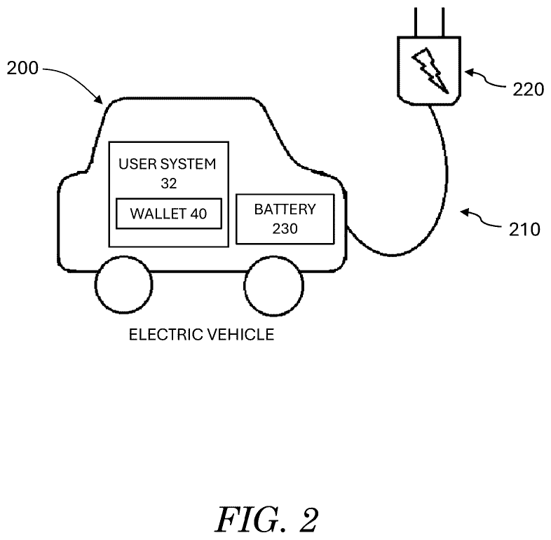

FIG. 2 is an example configuration of an electric vehicle (EV) 200, such as the EV 24 (shown in FIG. 1). In the example embodiment, the EV 200 includes an integrated user system 32, an electrical connector 220, and a battery 230. In some embodiments, the user system 32 includes the digital wallet 40. In the example embodiment, the electrical connector 220 may be integrated with the battery 230 of the EV 200 or may be connected to a charging cable 210 attached to the battery 230 of the EV 200.

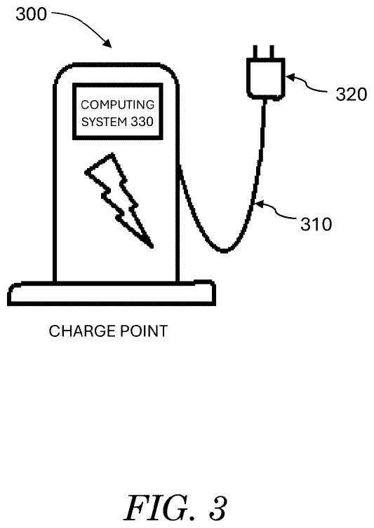

In the example embodiment, the electrical connector 220 is configured to be connected to a corresponding electric connector of a charge point, such as an electric connector 320 (shown in FIG. 3). Once the electrical connector 220 is connected to the corresponding connector of the charge point, electronic communication may be established between the user system 32 of the EV 200 and a computing device of the charge point. In the example embodiment, both data and electrical power may be transferred over the charging cable 210 and the connector 220.

In some embodiments, the charge point and/or the EV 200 communicates with various components of the system 10 (shown in FIG. 1) to authorize a transaction enabling a transfer of electrical energy from the charge point to the EV 200. In some embodiments, the EV 200 may be configured to receive, for example, one hundred and twenty (120) volts of alternating current (VAC), two hundred and forty (240) VAC, direct current (DC) power, or any other form of electrical energy from a corresponding charge point.

Electrical energy that is received by the EV 200 is provided to the battery 230 as a charging current. In some embodiments, the EV 200 may include various circuitry components (not shown), such as an input filter, a rectifier, one or more DC/DC converters, current sensors, voltage sensors, fault protection circuitry, and/or any other circuitry necessary to provide the charging current to the battery 230.

In some embodiments, the electrical connector 220 may be an electrical plug configured to be received by a corresponding receptacle of a charge point, such as the CP 34 (shown in FIG. 1). Alternatively, the connector 220 may be a receptacle configured to receive a corresponding electrical plug of the charge point. In an alternative embodiment, the connector 220 may be an inductive charging coil configured to wirelessly transfer data and electrical energy.

In some embodiments, the battery 230 may include one or more lithium-ion batteries, nickel-metal hydride batteries, lead-acid batteries, ultracapacitors a capacitor bank, and the like. The battery 230 may provide power to various electronic components of the EV 200 including at least one or more electric motors (not shown), a powertrain system (not shown), one or more auxiliary batteries (not shown), an electronic control unit (not shown), a vehicle display (not shown), the user system 32, and any other electronic circuitry requiring electric power as part of the operation of the EV 200.

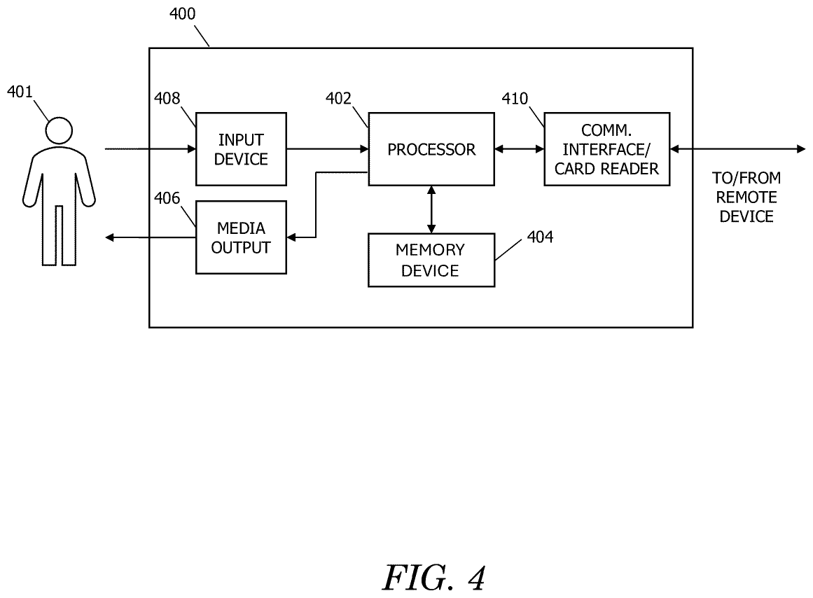

In the example embodiment, the user system 32 is integrated with the EV 200. The user system 32 includes the digital wallet 40. The digital wallet 40 is configured to store payment account information for one or more payment accounts of the consumer 22. In some embodiments, upon detecting a connection with a charge point, the user system 32 establishes communication with the connected charge point. The charge point sends merchant information to the EV 200. Subsequently, the EV 200 retrieves payment information from the digital wallet 40 and provides the payment information and the merchant information to the connected charge point via a communication interface, such as a communication interface 410 (shown in FIG. 4). After the payment information and the merchant information are processed, the EV 200 begins to receive a charging current from the charge point.

FIG. 3 is an example configuration of a charge point (CP) 300 operated by a charge point operator (CPO), such as the merchant 12 of the vehicle charging payment network system 10 shown in FIG. 1. In some embodiments, the CP 300 is one of the CPs 34 (shown in FIG. 1). In the example embodiment, the CP 300 includes a charging cable 310, an electrical connector 320, and a computing system 330. The charging cable 310 and electrical connector 320 are configured to convey both data and electrical energy between the CP 300 and an electric vehicle, such as the EV 200 (shown in FIG. 2). The electrical connector 320 is configured to connect with a corresponding electrical connector of an EV, such as the connector 220 of the EV 200 (shown in FIG. 2). The computing system 330 is configured to process data and communicate with various components of the system 10 (shown in FIG. 1).

In some embodiments, the electrical connector 320 may be a receptacle configured to receive a corresponding electrical connector of an electric vehicle, such as the electrical connector 220 of the EV 200 (shown in FIG. 2). In other embodiments, the electrical connector 320 may be a plug configured to be received by a corresponding receptacle of an EV, such as the electrical connector 220 of the EV 200 (shown in FIG. 2). In an alternative embodiment (not shown), the electrical connector 320 may be integrated in the CP 300 without the use of a charging cable. In another alternative embodiment, the electrical connector 320 may be an inductive charging coil configured to wirelessly transfer data and electrical energy. In some embodiments, the CP 300 may be configured to provide one hu8ndread and twenty (120) volts of alternating current (VAC), two hundred and forty (240) VAC, direct current (DC), or any other form of electrical energy to a corresponding EV.

In the example embodiment, the computing system 330 includes a communication interface, such as the communication interface 410 (shown in FIG. 4), to communicate with an EV, such as the EV 200 (shown in FIG. 2) and an associated CPO, such as the merchant 12 (shown in FIG. 1). In some embodiments, the computing system 330 provides merchant information, including unique identifiers associated with the CP and the CPO, to the EV. The EV returns account information and the merchant information to the CP. The CP then forwards the transaction information to the CPO. The CPO authorizes the transaction and instructs the CP to begin charging the EV Subsequently, the CP begins providing charging current to the EV. The communication interface may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

FIG. 4 is an example configuration of a computing system 400. In some embodiments, the computing system 400 is a user system 32 (shown in FIG. 1) operated by a user 401, such as the consumer 22 (shown in FIG. 1). The computing system 400 is also or alternately the CP computing system 330 (shown in FIG. 3). In some embodiments, the computing system 400 is integrated with the EV 24 (shown in FIG. 1). In the example embodiment, the computing system 400 includes a processor 402 for executing instructions. In some embodiments, executable instructions are stored in a memory device 404. The processor 402 includes one or more processing units in, for example, a multi-core configuration. The memory device 404 is any device allowing information such as digital wallet data, executable instructions, and/or written works to be stored and retrieved. The memory device 404 includes one or more computer readable media.

A location of the computing system 400 can be obtained through conventional methods, such as a location service (e.g., global positioning system (GPS) service) in the computing system 400, “ping” data that includes geotemporal data, from cell location register information held by a telecommunications provider to which the computing system 400 is connected, and the like. For example, in one suitable embodiment, a GPS chip can be part of or separate from the processor 302 to enable the location of the computing system 400 to be determined.

The computing system 400 also includes at least one media output component 406 for presenting information to the user 401. The media output component 406 is any component capable of conveying information to the user 401. In some embodiments, the media output component 406 includes an output adapter such as a video adapter and/or an audio adapter. An output adapter is operatively coupled to the processor 402 and operatively connectable to an output device such as a display device, a liquid crystal display (LCD), organic light emitting diode (OLED) display, or “electronic ink” display, or an audio output device, a speaker, or headphones.

In some embodiments, the computing system 400 includes an input device 408 for receiving input from the user 401. The input device 408 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 406 and the input device 408. The computing system 400 may also include a communication interface 410, which is communicatively connectable to a remote device such as the server system 30 (shown in FIG. 1), the EV 24 (shown in FIG. 1) and/or the CP 34 (shown in FIG. 1). The communication interface 410 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 404 are, for example, computer readable instructions for providing a user interface to the user 401 via the media output component 406 and, optionally, receiving and processing input from the input device 408. A user interface may include, among other possibilities, a web browser and a client application. Web browsers enable users, such as the user 401, to display and interact with media and other information typically embedded on a web page or a website from the server system 30. A client application allows the user 401 to interact with a server application from the server system 30. In the example embodiment, the memory device 404 may store digital wallet data corresponding to a digital wallet, such as the digital wallet 40 (shown in FIG. 1).

In the example embodiment, the computing device 400 is a user computing device from which the user 401 engages with a merchant (e.g., the merchant 12 shown in FIG. 1), an interchange network (e.g., the interchange network 16 shown in FIG. 1), and an issuer of a payment card (e.g., the issuer 18 shown in FIG. 1) to perform a payment transaction that undergoes an additional authentication process.

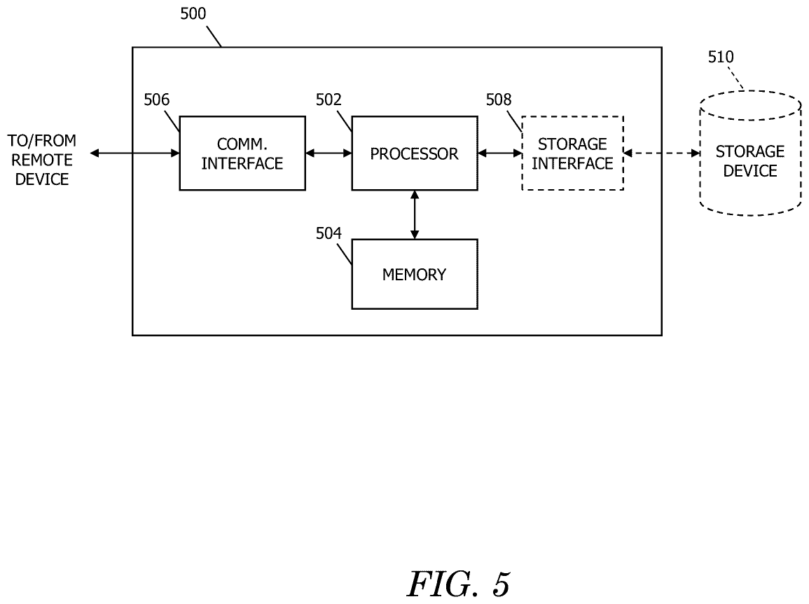

FIG. 5 is an example configuration of a server system 500, such as the server system 30 or eMSP computing system 28 (each shown in FIG. 1). In the example embodiment, the server system 500 includes a processor 502 for executing instructions. The instructions may be stored in a memory area 504, for example. The processor 502 includes one or more processing units (e.g., in a multi-core configuration) for executing the instructions. The instructions may be executed within a variety of different operating systems on the server system 500, such as UNIX, LINUX, Microsoft Windows®, etc. More specifically, the instructions may cause various data manipulations on data stored in a storage device 510 (e.g., create, read, update, and delete procedures), such as the database 26 (shown in FIG. 1). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 502 is operatively coupled to a communication interface 506 such that the server system 500 can communicate with a remote device such as the computing system 400 (shown in FIG. 4) or another server system. For example, the communication interface 506 may receive communications from the electric vehicle 24 or a user system 32 via the Internet, as illustrated in FIG. 2.

The processor 502 is operatively coupled to the storage device 510. The storage device 510 is any computer-operated hardware suitable for storing and/or retrieving data, such as the database 26 (shown in FIG. 1). In some embodiments, the storage device 510 is integrated in the server system 500. In other embodiments, the storage device 510 is external to the server system 500 and is similar to the database 26. For example, the server system 500 may include one or more hard disk drives as the storage device 510. In other embodiments, the storage device 510 is external to the server system 500 and may be accessed by a plurality of server systems 500. For example, the storage device 510 may include multiple storage units such as hard disks or solid-state disks in a redundant array of inexpensive disks (RAID) configuration. The storage device 510 may include a storage area network (SAN) and/or a network attached storage (NAS) system.

In some embodiments, the processor 502 is operatively coupled to the storage device 510 via a storage interface 508. The storage interface 508 is any component capable of providing the processor 502 with access to the storage device 510. The storage interface 508 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 502 with access to the storage device 510.

The memory area 504 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, server system 500 is an authentication processing system in communication with one or more of the acquirer 14, the issuer 18, and the merchant 12 during a payment card transaction associated with a user, such as the consumer 22 (shown in FIG. 1). The server system 500 performs checking for account restrictions for accounts (e.g., PANs) initiating a payment transaction and provides authentication services to a consumer associated with the payment transaction.

Payment Card Enrollment with Secure Remote Commerce (SRC) System

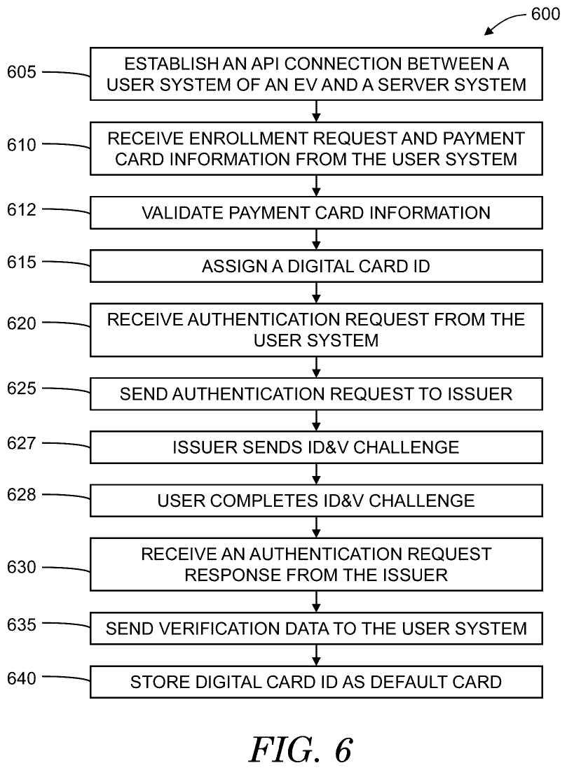

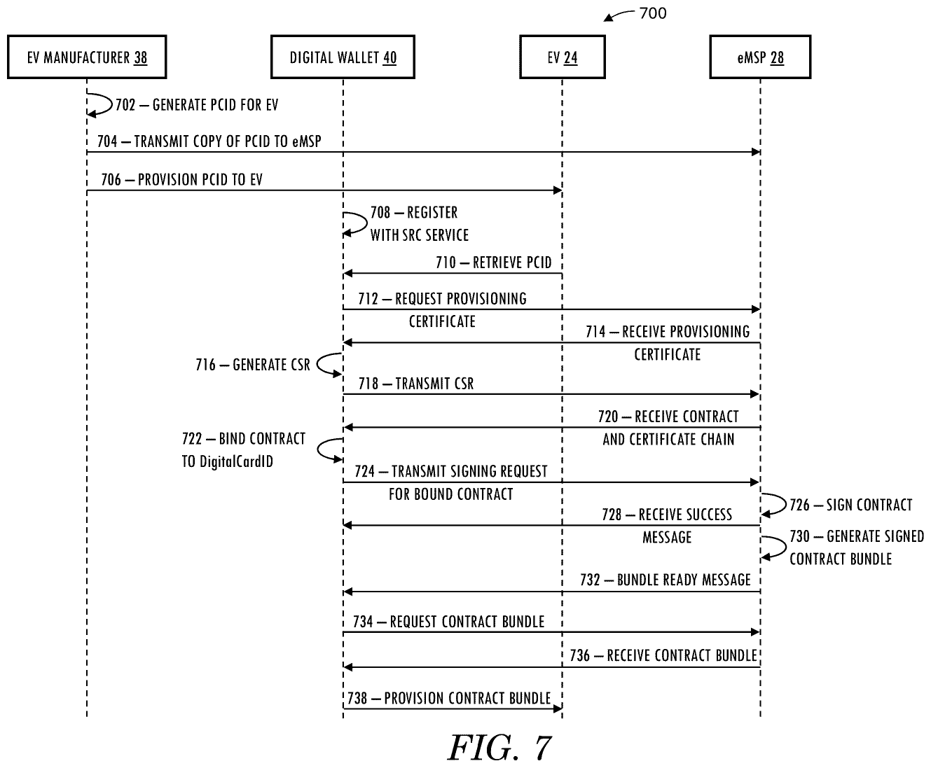

FIG. 6 is a process flow diagram of a method 600 for registering payment information of a user system (e.g. user system 32 shown in FIG. 1) associated with an electric vehicle (e.g. the EV 24 shown in FIG. 1) and used in transactions related to charging the electric vehicle. In one embodiment, the user system 32 may be integrated into the EV 24. In alternative embodiments, the user system 32 may include a mobile computing device, such as a smartphone, tablet, laptop, and the like. The user system 32 accesses a digital wallet application, such as the digital wallet 40 to register or enroll payment information with a Secure Remote Commerce (SRC) environment or framework (e.g., the server system 30 shown in FIG. 1) to obtain a digital credential (referred to herein as a “DigitalCardID”). The term “DigitalCardID” is used to denote a secure representation of underlying account data that enables transactions in digital wallet systems without exposing the original PAN.

At step 605, a secure application programming interface (API) connection is established between the digital wallet 40 of the user system 32 and the SRC system (e.g. the server system 30 shown in FIG. 1) via a communications interface (e.g. communication interface 410 shown in FIG. 4) of the user system 32. The digital wallet 40 interfaces with the SRC system, for example, via one or more secure APIs. The SRC system is configured to communicate with card issuers, token service providers, and other entities necessary for validating the card information and generating the DigitalCardID.

After communication is established, at step 610, the server system 30 receives an enrollment request, which includes payment card information, from the digital wallet 40 based on a user selection. For example, in an embodiment, upon requesting to add a new payment card, the user may be prompted to input relevant account data. The user selection may include entering the payment card information into a graphical user interface (GUI) of the user system 32. The payment card information may include: (1) a PAN, an expiration date, and a card security code associated with a payment card; and (2) associated user information, such as a name, address, phone number, and/or other user information. Alternatively, in certain implementations, the user may select a payment card already on file with an issuer or a third-party wallet aggregator (such as the EV manufacturer, rental car company, fleet manager, etc.). The digital wallet 40 may collect these data elements and prepare them for secure transmission to the server system 30.

The digital wallet 40 typically encrypts or otherwise protects the payment card information prior to transmission. The server system 30 may further employ its own transport security protocols, ensuring that sensitive information is only accessible to authorized components. In some embodiments, the server system 30 may generate a cryptographic nonce or session token, which is used to bind the enrollment session to subsequent steps in the process, mitigating risk of replay attacks or data interception.

At 612, after the user's payment card information is received by the server system 30, an enrollment orchestration service interfaces with the issuer 18 (shown in FIG. 1) or interchange network 16 (shown in FIG. 1) to perform card validation. The validation process may include account status checks to confirm the payment card is active and in good standing.

At step 615, the server system 30 assigns a payment card identifier (the DigitalCardID). Again, the DigitalCardID is associated with the payment card information and serves as a secure proxy for the PAN. The server system 30 may store the DigitalCardID in a database (e.g. the database 26 shown in FIG. 1). The DigitalCardID may be stored in the database 26 with the payment card information. The DigitalCardID is cryptographically bound to the user's account and contains sufficient metadata to facilitate digital wallet transactions, while preventing exposure of the true PAN during payment processing. The server system 30 sends the DigitalCardID to the user system 32 via the secure API connection.

Concurrent with generation of the DigitalCardID, the user may undergo authentication to verify identity. In the example, at step 620, the server system 30 receives an authentication request, as part of the enrollment request, from the user system 32. When the user submits the enrollment information (e.g., the payment card information and associated user information) through the digital wallet 40, the server system 30 analyzes the information and determines whether further identity verification is required. In some embodiments, a set of risk evaluation rules or fraud-detection parameters triggers the need for a card issuer-led identity verification (ID&V) process. Upon detecting such a requirement, at step 625, the server system 30 transmits an ID&V request to the issuer 18, for example, using a secure communication channel (e.g., mutually authenticated TLS).

At step 627, after receiving the ID&V request, the issuer 18 transmits an ID&V challenge to the user, via the user system 32 or digital wallet 40, for example. More particularly, in an embodiment, the issuer 18 initiates an authentication session, which may include session identifiers, timeouts, and cryptographic nonces to ensure the integrity of the ID&V challenge process. These session parameters facilitate ensuring that subsequent interactions with the user, via the user system 32, are bound to the specific enrollment process, thereby mitigating the risk of replay or man-in-the-middle attacks. The ID&V challenge may vary depending on the issuer. For example, the issuer 18 may: (1) transmit a one-time passcode (OTP) to the user system 32, sent via short message service (SMS), push notification, or email; (2) employ push-based authentication by pushing a secure message to the user system 32, prompting the user to confirm card enrollment within the issuer's mobile application; or (3) employ knowledge-based questions requiring correct answers to personal or transactional history questions. It is noted that other ID&V challenge processes may be employed, as known to one skilled in the art. The ID&V challenge may be presented to the user through the digital wallet 40 or via a separate authenticated channel (e.g., the issuer's mobile application installed on the user system 32). If directed through the digital wallet 40, an API call from the issuer 18 to the server system 30 may provide instructions, which the server system 30 then relays to the digital wallet 40 for display.

At step 628, after receiving the ID&V challenge, the user completes the challenge, for example, by providing the requested authentication input (e.g., entering an OTP). In an example, the digital wallet 40 may collect the user input and securely forward it to the issuer 18 (potentially via the server system 30). As noted above, the transmission may be protected by end-to-end encryption, based on the session parameters described above, to ensure that the user input is inaccessible to unauthorized entities.

Upon receipt of the ID&V challenge response from the user, the issuer 18 verifies its correctness against the previously generated challenge values or stored user records. For example, if an OTP is used, the issuer 18 verifies the user-supplied code within a prescribed time window. If the verification is successful, the issuer 18 marks the authentication session as verified, logging the outcome and generating an authentication result token or similar data structure containing the verification status (e.g., verification data).

At step 630, if authentication is successful, the server system 30 receives an indication of successful authentication from the issuer 18. For example, the server system 30 may receive the verification data, which may include success status, timestamp, and any relevant risk scoring, from the issuer 18. The verification data may be accompanied by additional issuer-provided metadata indicating, for example, whether the user system 32 information is consistent with known device profiles or if further checks are recommended. The server system 30 may process this result and update the enrollment session associated with the DigitalCardID.

If authentication is not successful, the method 600 returns to step 620 if the user chooses to re-submit authentication information. Otherwise, the method 600 ends upon unsuccessful authentication.

At step 635, the server system 30 sends verification data to the user system 32 indicating that the authentication was successful. For example, the server system 30 may compile a verification data package containing, for example, a “verified” flag, the newly generated DigitalCardID, and instructions on default card preferences if so designated by the user or the issuer 18. The server system 30 may transmit the verification data package to the digital wallet 40 using secure messaging protocols (e.g., JSON or XML over TLS).

At step 640, the user system 32 stores the DigitalCardID in the digital wallet 40. For example, the user system 32 or digital wallet 40 may receive the verification data package, extract the DigitalCardID therefrom, and update its internal record of stored payment credentials. In certain embodiments, the digital wallet 40 may be configured to automatically set the newly verified card as the default method of payment. If a default card assignment is indicated, the digital wallet 40 may modify its local or cloud-based credential store to mark the newly provisioned DigitalCardID as the primary card. Such an action ensures that subsequent transactions default to this credential, streamlining the checkout experience.

### Contract Generation

FIG. 7 is a sequence diagram of a method 700 for generating a contract that is bound to the DigitalCardID (e.g. the DigitalCardID described in FIG. 6) and provisioning the contract to the EV (e.g. the EV 24 shown in FIG. 1). Initially, at step 702, a manufacturer 38 of the EV 24 generates a provisioning certificate identifier (PCID) for the EV 24. The PCID is a unique digital code that identifies an electric vehicle (EV). The PCID may be used, for example, during a plug-and-charge process, a feature that allows EVs to automatically charge and pay for charging sessions with little to no additional user action. This PCID may be embedded in a certificate or metadata that references a cryptographic key pair or a unique identifier. At step 704, the EV manufacturer 38 transmits a copy of the PCID to the eMSP 28. More particularly, the PCID is transmitted to the eMSP's provisioning certificate pool (PCP) 42, which functions as a repository for provisioning-related certificates, keys, and/or reference data. In addition, at step 706, the EV 24 is provisioned with the PCID. The PCID may be stored in a secure hardware component, such as a microcontroller with built-in secure storage, or a Trusted Platform Module (TPM), of a computing device integrated with the EV 24 (e.g., in some embodiments, the user system 32). By securing the PCID within the EV 24, the EV 24 can later authenticate to eMSP services with minimal risk of key compromise.

At step 708, a user, such as the consumer 22, enrolls a payment card with the SRC system (e.g. the server system 30 shown in FIG. 1), as described above in method 600. The SRC system is recognized by all participating charge point operators (CPOs) or merchants 12. As described above, the enrollment process generates the DigitalCardID (or tokenized representation of the user's payment method), which is passed to the digital wallet 40. The digital wallet 40 registers with the SRC system as a digital card facilitator, enabling the digital wallet 40 to request certificates on behalf of the consumer 22 and to bind those certificates to a valid payment credential (i.e., the DigitalCardID). It is noted that subsequent cryptographic operations and certificate requests by the digital wallet 40 may be authenticated against the SRC system's root certificate authority (CA) hierarchy.

At step 710, in order to establish a contract for EV charging services, the digital wallet 40 retrieves the PCID directly from the EV 24. In an embodiment, the EV 24 may transmit the PCID over any secure link established with the digital wallet 40, such as, a TLS-encrypted Bluetooth or Wi-Fi direct channel, or an on-board diagnostic (OBD) interface protected by additional security layers.

At step 712, after obtaining the PCID from the EV 24, the digital wallet 40 requests a provisioning certificate from the eMSP 28. For example, in an embodiment, the digital wallet 40 contacts the eMSP's PCP 42 (via an HTTPS-based API, for example, GET/oem/provCerts?pcid=<PCID>) to obtain the provisioning certificate or its associated certificate chain. The PCP 42 may be responsible for maintaining a database of valid certificates used during the initial provisioning steps. At step 714, in response to the provisioning certificate request, the PCP 42 transmits the provisioning certificate to the digital wallet 40.

At step 716, the digital wallet 40 generates a certificate signing request (CSR). For example, in the example embodiment, the digital wallet 40 may generate a new public/private key pair (i.e., an asymmetric key pair) for the EV's future contract certificate (broadly, a contract). In one example, the private key may be encrypted using the public key from the provisioning certificate (retrieved from the PCP 42, as described above). For instance, a symmetric key (e.g., generated by the digital wallet 40) may be used to encrypt the private key, and that symmetric key may be further encrypted by the public key portion of the provisioning certificate. This ensures that only an authorized entity with the corresponding private key to the provisioning certificate can decrypt the EV's private key. After the key pair is generated, the digital wallet 40 may construct the CSR. The CSR may contain the public key, the DigitalCardID, the PCID, an indication of consumer device consumer verification method (CDCVM) capability, and the full qualified domain name of the SRC system (e.g., https://www.srcsystem.com.). In an embodiment, the CSR may be formatted in accordance with X.509 standards (e.g., PKCS #10) and may include subject alternative name (SAN) extensions referencing an eMobility account identifier (EMAID).

At step 718, to obtain a signed leaf certificate, the digital wallet 40 transmits the CSR to the eMSP 28. For example, the digital wallet 40 may transmit the CSR to the EST for V2G module 44. The module 44 may enforce a secure data exchange protocol, such as TLS v1.2 or v1.3, to preserve the confidentiality and integrity of the transmitted CSR. In an example, the EST for V2G module 44 may verify the request, check that the PCID references a valid OEM record in the PCP 42, and validate the DigitalCardID against the SRC system's Root CA if necessary.

At step 720, the eMSP 28 returns a contract certificate and certificate chain to the digital wallet 40. For example, in an embodiment, upon successful validation, a subordinate CA (CA Sub 1)—which is signed by the SRC System Root CA—issues and signs the EV contract certificate, forming a certificate chain (Leaf→CA Sub 1→SRC System Root CA). The initial “contract” data, including the newly signed leaf certificate and any intermediate certificates, may be returned to the digital wallet 40. In some implementations, the eMSP 28 may embed or link additional contract terms in a structured format compatible with ISO 15118 (e.g., “Contract Certificates” or “CertificateInstallationReq/Res” messages) or Open Charge Point Protocol (OCPP).

At step 722, the digital wallet 40 performs a contract binding process (described in more detail below with respect to method 800), in which the digital wallet 40 transmits the certificate chain and associated parameters to the bind API of the SRC system. The API call may include the DigitalCardID, the signed certificate, and any additional metadata necessary for contract validation. The SRC system, acting as the trust anchor for identity and payment, validates the chain against its Root CA certificate. After approval, the SRC system may record the association (i.e., that a particular DigitalCardID is authorized to use this contract certificate) in its internal database and returns a confirmation to the digital wallet 40.

At step 724, the digital wallet 40 transmits the bound contract to the eMSP 28. For example, in an embodiment, the CPS 46 of the eMSP 28 framework, receives the signed contract data from the digital wallet 40 (e.g., via call/cps/forward/signedContractData). The contract data payload may include, for example: (1) the contract and the complete certificate chain, (2) the encrypted private key (and ephemeral key exchange data, e.g., Diffie-Hellman public parameters), (3) the PCID, and (4) the EMAID or other usage policies.

At step 726, the CPS 46 confirms that the contract is authentic, adds a further eMSP signature or timestamp, and transmits it to the CCP 48. In an embodiment, the CCP 48 may be configured to finalize, store, and distribute contract bundles-which may be XML-based (conforming to ISO 15118 or OCPP schemas) or in other machine-readable formats. In some embodiments, the CPS 46 could be merged with the CCP 48. At step 728, the CPS 46 returns a message to the digital wallet 40 indicating that the contract was successfully signed.

At step 730, the CCP 48 generates a signed contract bundle. At step 732, after the contract bundle is fully assembled, the CCP 48 notifies the digital wallet 40 that the contract is available for retrieval. At step 734, the digital wallet 40, using a secure transport protocol (such as TLS), calls an endpoint like GET/ccp/signedContractData?pcid=<PCID> and, at step 736, downloads the finalized signed contract bundle. The bundle may include, for example, the signed leaf certificate, the Sub CA certificate, relevant signatures from the eMSP 28, and any policy or rate tables mandated by ISO 15118 or OCPP.

At step 738, the digital wallet 40 provisions the contract bundle to the EV 24, which stores it in a secure storage module or hardware element, as described herein. Upon connecting to a CP 34 that trusts the SRC System Root CA (and thus also trusts CA Sub 1), the EV 24 automatically authenticates via the presented contract certificate. Because the EV 24 and the CP 34 share a recognized Root CA, the CP 34 can confirm the contract validity and use the user's linked DigitalCardID for billing and settlement through the SRC system, as described in detail below.

### Binding Digital Card Id to Contract

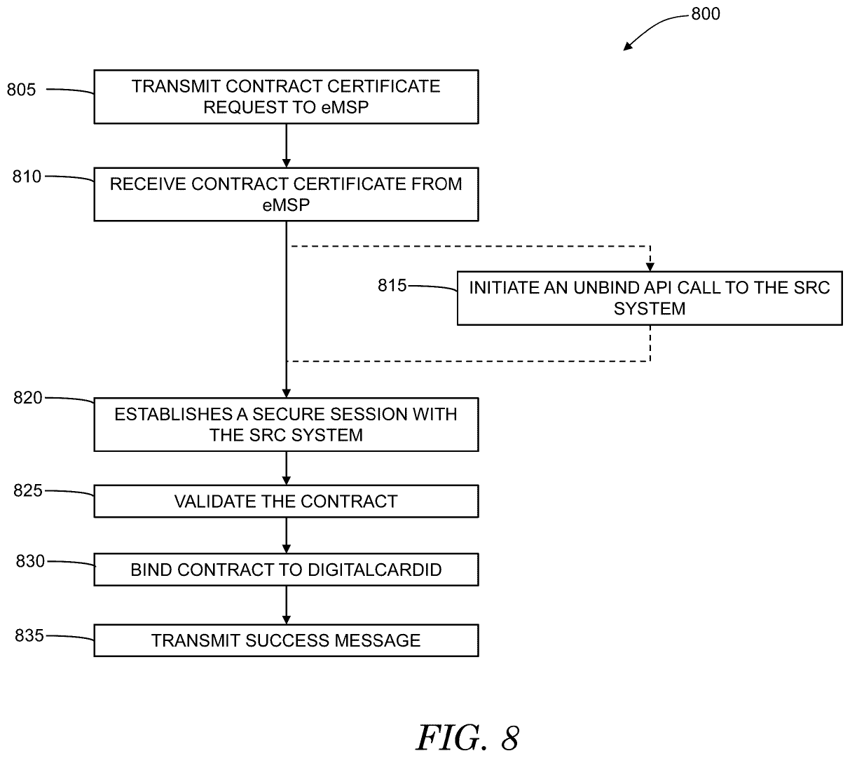

FIG. 8 is a process flow diagram of a method 800 for binding a DigitalCardID (e.g. the DigitalCardID described in FIG. 6) to the contract certificate (and certificate chain) generated by the eMSP 28. At step 805, the digital wallet 40 transmits a contract certificate request to the eMSP 28. (See step 718 above for additional details.) At step 810, the eMSP 28 returns a contract certificate to the digital wallet 40. (See step 720 above for additional details.) The digital wallet 40 may be a digital wallet application executed by the user system 32. In one embodiment, the user system 32 may be integrated into the EV 24. In alternative embodiments, the user system 32 may include a mobile computing device, such as a smartphone, tablet, laptop, and the like.

In some embodiments, if the digital wallet 40 cannot store different contracts for multiple DigitalCardIDs, the digital wallet 40 first needs to remove (or “unbind”) any previously active contracts before binding a new one. This ensures that the EV 24 is associated with only one valid contract at a time. Accordingly, at optional step 815, the digital wallet 40 may initiate an unbind API call to the SRC system (e.g. the server system 30 shown in FIG. 1). The digital wallet 40 may communicate over the API via a communications interface (e.g. communication interface 410 shown in FIG. 4) of the user system 32. In an example, the API call may include the HTTP Method/Endpoint “DELETE/profiles/appinstances.” The parameters may include, for example, and without limitation: (1) a serviceID, which may identify the eMSP service or subscription to unbind; (2) an srcClientID, which may include the digital wallet's SRC identifier; (3) the DigitalCardID, which may include the currently bound payment credential token; (4) a device identity, which may include a unique descriptor of the digital wallet device (e.g., serial number, hardware identifier, etc.); and (5) the contract (including the certificate chain up to CA Sub 1), which may include the existing contract certificate data to be unbound. In some embodiments, after the SRC system receives the unbind request, the SRC system may locate the binding record in a binding database (not shown) using the supplied parameters. The SRC system may remove and/or revoke the contract binding so that subsequent authentication or payment attempts under the old contract are no longer recognized. The SRC system may return an HTTP 200 or 204 success status to confirm that the contract has been unbound. If the contract is invalid or cannot be found, the SRC system may return an HTTP 404 or 400 error with diagnostic information.

At step 820, after ensuring that any prior contract binding has been removed (if applicable), the digital wallet 40 establishes a secure session with the SRC system, and more particularly, the bind API. For example, in an embodiment, the digital wallet 40 may call the bind API using the HTTP Method/Endpoint “POST/profiles.” In certain embodiments, mutual TLS may be used, requiring both client and server certificate authentication. In addition, in other embodiments, the digital wallet 40 may typically supply credentials (e.g., OAuth tokens or an API key) to prove it is a registered digital card facilitator.

In the example embodiment, the API call parameters may include, for example, and without limitation: (1) a serviceID; (2) an srcClientID; (3) the DigitalCardID; (4) a device identity; and (5) the contract (including the certificate chain up to CA Sub 1). The contract may include, for example, the newly created or updated contract certificate for the EV 24, signed by CA Sub 1 (which itself is under the SRC system's Root CA). The parameter may include the leaf certificate (representing the EV's public key and identity), any intermediate certificates up to the CA Sub 1, and any supporting policy or metadata, such as tariff details, expiration dates, or references to the user's EMAID.

At step 825, the SRC system validates the contract. For example, in an embodiment, the SRC system may check the validity of the TLS session and verify that clientID matches a registered digital card facilitator. If mutual TLS is enabled, the SRC system may also examine the client-side certificate to confirm that it chains back to a trusted authority. The SRC system may also perform certificate chain verification steps. For example, the SRC system may parse the assurance data and reconstruct the certificate chain from the leaf certificate up to the CA Sub 1, which should ultimately reference the SRC System Root CA. In an example, the chain may be validated according to X.509 standards, checking expiration dates, signatures, and optionally performing revocation checks. The SRC system may perform a binding consistency check. For example, the SRC system may confirm that the DigitalCardID has not previously been bound to a different contract under the same serviceID (unless multiple bindings are allowed by policy). Similarly, the SRC may ensure that the device identity is associated with a recognized device.

At step 830, the SRC system associates the contract with the DigitalCardID. For example, after the certificate chain has been validated, the SRC system associates (binds) the DigitalCardID with the newly verified contract certificate in a binding database (not shown). The record or database entry ensures that subsequent charging or authentication attempts referencing the certificate chain will resolve to the specified DigitalCardID for billing and/or identity purposes.

At step 835, the SRC system responds to the digital wallet 40 with a success message (e.g., an HTTP 200 message) indicating that the contract binding is active. If an issue arises—such as an invalid certificate, an unrecognized device, or a conflict with an existing binding—the SRC system may reply with an error message (e.g., HTTP 400 or 409 message).

At this point, the digital wallet 40 and the EV 24 (once provisioned with this certificate bundle, as described above at step 738) can engage in plug-and-charge transactions. As described below in detail, when the EV 24 presents the certificate chain at a cooperating CP 34 that trusts the SRC System Root CA, the CP 34 will validate the contract. The SRC system then facilitates transaction processing via the DigitalCardID, providing a frictionless charging experience without requiring manual payment input.

### Contract-Based Payment Transaction Flow

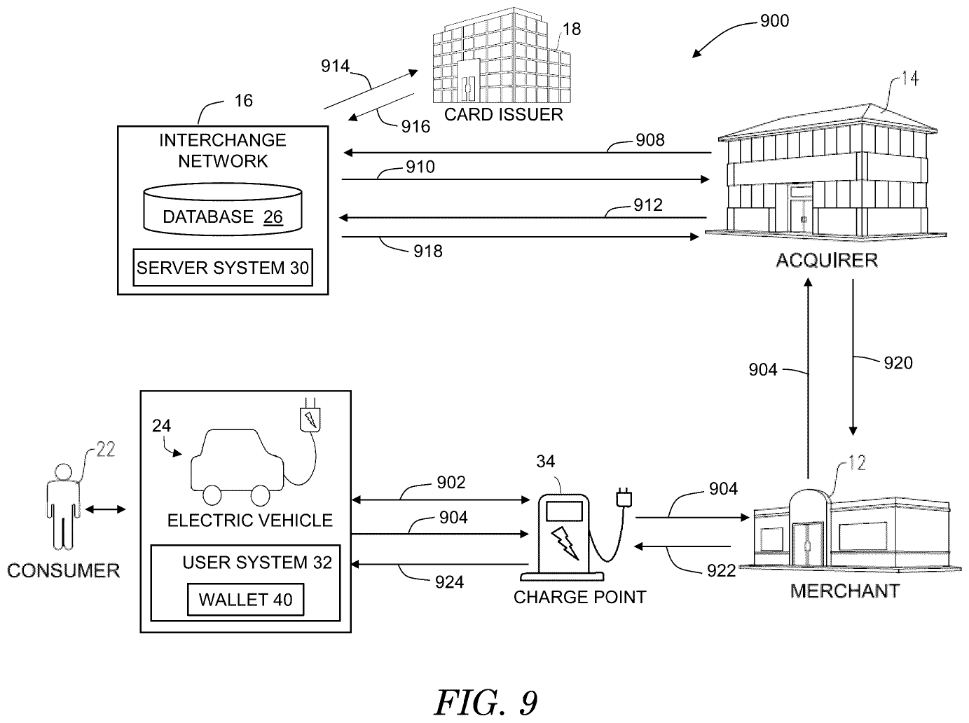

FIG. 9 is a schematic diagram of the system 10 showing a data flow 900 among the parties during a payment transaction for charging an electric vehicle, such as the EV 24. In the example embodiment, the payment transaction is a card-not-present (CNP) transaction where the consumer 22 initiates the payment transaction using, for example, and without limitation, account information of a payment account stored in the digital wallet 40 of the user system 32 to provide payment information associated with a cost of charging the EV 24. In the example embodiment, the user system 32 may be integrated with the EV 24. The user system 32 includes the digital wallet 40.

In the example embodiment, the CP 34 includes a merchant computer device, such as the computing system 330 (shown in FIG. 3). When the consumer 22 selects to initiate a transaction with the CP 34, the consumer connects an electrical connector of the EV 24 (e.g. electrical connector 220 shown in FIG. 2) with an electrical connector of the CP 34 (e.g. electrical connector 320 shown in FIG. 3) to exchange handshaking information 902 as part of a handshaking procedure for establishing communication. The EV 24 and CP 34 establish a mutually authenticated and encrypted session through the handshaking procedure. This involves exchanging digital certificates for authentication and key exchange, resulting in an encrypted communication channel over a TCP/IP connection (e.g., over a TLS-encrypted session). It is noted that the messages between the EV 24 and the CP 34, may, in at least some instances, conform to the International Organization for Standardization (ISO) Standard 15118, vehicle to grid communication interface, which is the ISO standard for systems that exchange electronic messages between an electric vehicle and an electric grid. In the example embodiment, the handshaking information 902 can be a plurality of ISO 15118 type messages.

In a preferred embodiment, the EV 24 and the CP 34 may exchange messages to confirm which ISO 15118 variant (or other protocol) they will use, for example, via “SupportedAppProtocolReq/Res” message exchange. Once decided, the EV 24 may transmit a “SessionSetupReq” message to the CP 34. The request may include an electric vehicle communication controller identifier (EVCCID) signed by the EV's private key, along with its EVCC certificate chain. The CP 34 may reply with a “SessionSetupRes” message, providing a unique SessionID, an electric vehicle supply equipment ID (EVSEID (i.e., the CP ID)), and the supply equipment communication controller (SECC) certificate chain. These steps ensure the EV 24 and CP 34 can authenticate one another via mutual TLS (mTLS) and that subsequent communication remains confidential and tamper-resistant. The handshaking information 902 received by the EV 24 from the CP 34 may also include merchant information. The merchant information may include a unique ID of the merchant 12 and/or other merchant information.

After secure communication is established between the CP 34 and the EV 24, the EV 24 signals its intent to initiate payment for charging services. In response, the CP 34 provides a list of supported payment services. The EV 24 then selects to pay via contract and generates authentication information 904. The authentication information 904 includes, for example, a timestamp, a challenge response (e.g., returns a random number received from the CP 34), and the contract (described above), and optionally, other verification information and/or merchant information. The EV 24 signs the authentication information 904 with a private key of the EV to encrypt the authentication information 904.

If the ISO 15118-2 standard is selected for the session, in an example embodiment where the CP 34 supports contract-based payments (e.g., Plug-and-Charge (PnC)) and has the necessary root certificate authority for the SRC System (i.e., the server system 30), the EV 24 may transmit a “ServiceDiscoveryReq” message to the CP 34 to inquire about available services at the CP 34. The CP 34 may return a “ServiceDiscoveryRes” message containing a payment service list that identifies the supported payment methods. The list might include external identification means (EIM), contract-based payment options, or others depending on the CP's configuration. The EV 24 may select, for example, the contract-based option by sending a “PaymentServiceSelectionReq” message that specifies “SelectedPaymentOption=Contract” to the CP 34. The CP 34 may respond with a “PaymentServiceSelectionRes” confirming that contract-based payment is permissible for the charging session. Before the EV 24 shares the contract details, the EV 24 must perform a consumer device cardholder verification method (CDCVM) if required for the transaction. The EV 24 may transmit a “PaymentDetailsReq” message containing the contract and certificate chain, and an electric mobility account identifier (EMAID). This data may prove that the EV 24 holds a valid contract tied to the EMAID. The CP 34 may return a “PaymentDetailsRes” message, providing a newly generated challenge (GenChallenge) for security. The EV 24, having received the challenge, may sign the challenge locally using the private key of the contract. The signing action may be implicit in the transaction flow but critical for non-repudiation. The EV 24 may transmit an authorization request message back to the CP 34, including the signed challenge, to prove that the EV 24 controls the contract and private key. The CP 34 may forward the authorization request to the merchant 12. In an example, the authorization request may be carried via the open charge point protocol (OCPP) “AuthorizeRequest” message, which includes the contract certificate chain, the signed challenge data, and a timestamp.

In an alternative embodiment, when using the ISO 15118-20 standard, and if the CP 34 supports its advanced PnC features and recognizes the server system 30 (i.e., the SRC system) as an eMobility Service Provider (eMSP), the EV 24 may send an “AuthorizationSetupReq” message to the CP 34. The message may include a session ID, a timestamp, and a digital signature. The CP 34 may respond with an “AuthorizationSetupRes” message that reaffirms the session details, lists the supported services (e.g., EIM, PnC), and includes a “PnC_ASResAuthorizationMode” parameter. The “PnC_ASResAuthorizationMode” parameter may include a random challenge number (UN); a roster of supported providers, among them the relevant SRC-based eMSP; and a request that the EV 24 provide its contract certificate chain. The message, including the challenge, is signed by the CP 34 and stored in “Authorization Data.” The EV 24 selects the contract to use based on one or more of the following: supported providers, default card contract, preferred contract for current merchant (i.e., CSO), and CDCVM status.

The EV 24 may transmit an authorization request message back to the CP 34, referencing the session ID, a timestamp, and specifying the selected authorization service (PnC). The authorization response may also include the “PnC_AReqAuthorizationMode” parameter. The “PnC_AReqAuthorizationMode” parameter may include the random challenge number (UN) and the contract (signed by the SRC System and including the EV's EVCCID). The EV 24 may sign the payload with its own private key. The CP 34 may encapsulate the authorization request data into an OCPP “AuthorizeRequest” message. The “AuthorizeRequest” message includes the contract, the UN challenge, the timestamp, and an “IdToken” field to carry the EV's signature.

Referring back to FIG. 9, in the depicted embodiment, regardless of whether ISO 15118-2 or ISO 15118-20 is used, the CP 34 provides the authentication information 904 to the merchant 12. Optionally, the merchant 12 may forward the authentication information 904 to its acquirer 14.

In the exemplary embodiment, the merchant 12 or the acquirer 14 (1) extracts the DigitalCardID from the contract, (2) extracts the IdToken that includes the signed data from the EV, (3) creates a “DpaTransactionOptions” parameter (which might contain details about the transaction amount, pricing, or currency), and (4) creates a checkout request message with these components in the assurance data. The checkout request message is a structured message initiated by a digital payment application (DPA) to facilitate an online transaction.

The merchant 12 or acquirer 14 transmits the checkout request message 908 to the server system 30 (i.e., the SRC system). The checkout request message 908 includes the authentication information 904, the extracted IdToken, and the extracted DigitalCardID. The server system 30 parses the checkout request message 908 to verify the authenticity and integrity of the payload. For example, the server system 30 verifies the EV's signature (e.g., using the EV's public key and via a trust chain) to confirm that the data (e.g., contract, challenge) has not been altered. The server system 30 also verifies the merchant's signature in a similar manner. The server system also verifies the DigitalCardID binding, i.e., that it corresponds to a valid payment credential (e.g., a tokenized card or PnC contract) recognized by the system. The server system 30 checks that the contract data matches what is registered for the EV 24 and that the contract has not been revoked or expired.

After validating the data elements received in the checkout request message and determining that the DigitalCardID is validly bound, the server system 30 may retrieve the associated payment credentials, such as the Primary Account Number (PAN) and other necessary card details, or generate a payment token and cryptogram for the transaction. The server system 30 then generates a checkout response message 910. The checkout response message 910 may include the payment credentials (i.e., the PAN, token, or cryptogram) and a correlationID. The correlationID is a unique identifier created by the server system 30 to link all the events and messages related to the transaction. The server system 30 transmits the checkout response message 910 to the merchant 12 or acquirer 14. If the binding validation fails—for example, if the DigitalCardID is expired, revoked, or does not match the EV identity in the contract—the server system 30 declines the request and returns an error or failure status indicating the reason for the mismatch.

In the example embodiment, after receiving the checkout response message 910, the merchant 12 or acquirer 14 proceeds with processing a payment authorization. For example, the merchant 12 or acquirer 14 extracts payment credentials from the checkout response message 910 and sends an authorization request message 912 to the interchange network 16. The authorization request message 912 may include the payment credentials and all necessary transaction details to process the payment transaction. The interchange network may enrich the authorization request message 912 as required and forward an enriched authorization request message 914 to the issuer 18.

The issuer 18 processes the enriched authorization request message 914 to pre-authorize a payment amount included in transaction details. The issuer 18 parses the enriched authorization request message 914 to identify a PAN associated with the payment account of the consumer 22. The issuer 18 subsequently determines whether the payment account includes sufficient available funds for processing the transaction. If the payment account includes sufficient funds to complete the transaction, the issuer 18 determines that authorization is successful and sends an authorization request response message 916 to the server system 30. Otherwise, the issuer 18 determines that the authorization failed and sends an authorization failure message to the server system 30.

Upon receiving the authorization request response message 916, the server system 30 sends an authorization request response message 918 to the merchant 12 or acquirer 14, indicating that the authorization was successful. If the acquirer 14 received the authorization request response message 918, the acquirer 14 transmits an authorization request response message 920 to the merchant 12. The authorization request response message 920 includes an indication of whether the authorization was successful.

Upon receiving an authorization failure message, the server system 30 may send a failure message to user system 32, indicating that the authorization was unsuccessful. Upon receiving the failure message, the consumer 22 may select a different payment method stored in the digital wallet 40 and submit new transaction information, including information identifying the different payment method.

If the authorization request response message 920 received by the merchant 12 indicates that the authorization was successful, the merchant 12 sends an instruction 922 to the CP 34 to begin charging the EV 24. For example, in a preferred embodiment, the merchant 12 may transmit an OCPP “AuthorizeResponse” to the CP 34. The response may include an “idTokenInfo” parameter (e.g., whether the authorization was accepted, blocked, expired, etc.) and may also include a “certificateStatus” parameter relevant to PnC-based contracts.

The CP 34 transmits an authorization response message 924 to the EV 24, indicating the authorization was successful. For example, if using ISO 15118-2 (as discussed above), the CP 34 may send an “AuthorizationRes” message, typically containing a “ResponseCode” (e.g., accepted or rejected) and an “EVSEProcessing” parameter that indicates whether the EV 24 can immediately start charging or if the CP 34 requires more time to finalize setup. Alternatively, if using ISO 15118-20, the “AuthorizationRes” message may additionally include the SessionID, making the session reference explicit while still conveying the outcome and next steps for charging.

### Push Remote Payment Transaction Flow

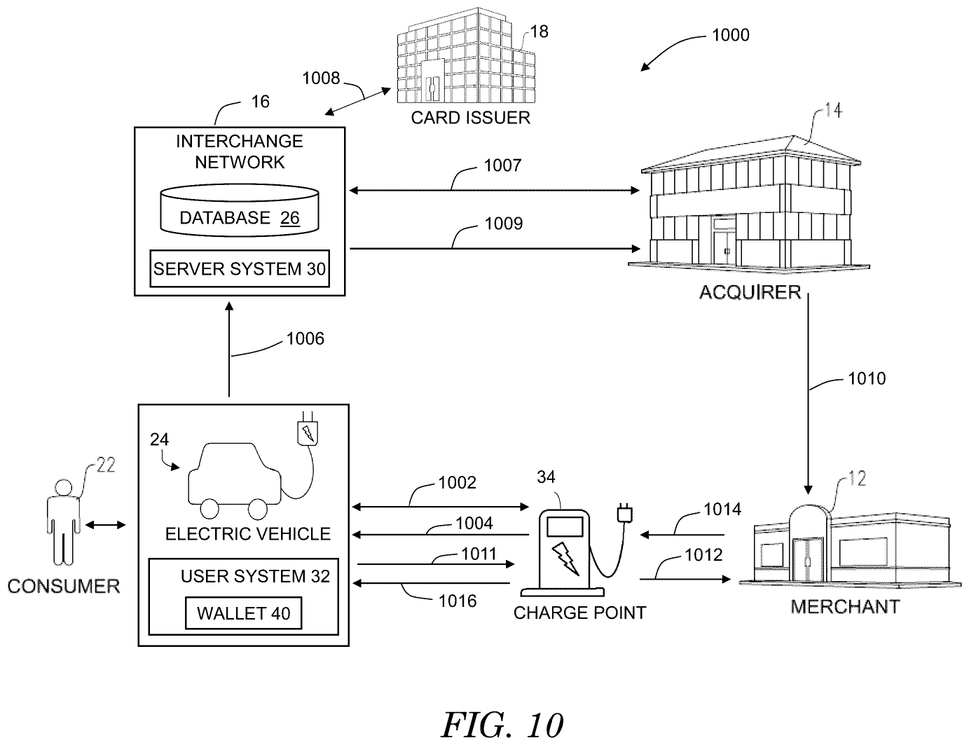

FIG. 10 is a schematic diagram of the system 10 showing an alternative data flow 1000 among the parties during a payment transaction for charging an EV. In this alternative embodiment, the payment transaction is a card-not-present (CNP) transaction where the consumer 22 initiates the payment transaction using, for example, and without limitation, account information of a payment account stored in the digital wallet 40 of the user system 32 to provide payment information associated with a cost of charging the EV 24. In the example embodiment, the user system 32 may be integrated with the EV 24. The user system 32 includes the digital wallet 40.

In the example embodiment, the CP 34 includes a merchant computer device, such as the computing system 330 (shown in FIG. 3). When the consumer 22 selects to initiate a transaction with the CP 34, the consumer connects an electrical connector of the EV 24 (e.g. electrical connector 220 shown in FIG. 2) with an electrical connector of the CP 34 (e.g. electrical connector 320 shown in FIG. 3) to exchange handshaking information 1002 as part of a handshaking procedure for establishing communication. The EV 24 and CP 34 establish a mutually authenticated and encrypted session through the handshaking procedure. This involves exchanging digital certificates for authentication and key exchange, resulting in an encrypted communication channel over a TCP/IP connection (e.g., over a TLS-encrypted session). It is noted that the messages between the EV 24 and the CP 34, may, in at least some instances, conform to the International Organization for Standardization (ISO) Standard 15118, vehicle to grid communication interface, which is the ISO standard for systems that exchange electronic messages between an electric vehicle and an electric grid. In the example embodiment, the handshaking information 1002 can be a plurality of ISO 15118 type messages.

In a preferred embodiment, the EV 24, via the user system 32, and the CP 34 may exchange messages to confirm which ISO 15118 variant (or other protocol) they will use, for example, via “SupportedAppProtocolReq/Res” message exchange. Once decided, the user system 32 may transmit a “SessionSetupReq” message to the CP 34. The request may include an electric vehicle communication controller identifier (EVCCID) signed by the EV's private key, along with its EVCC certificate chain. The CP 34 transmits merchant information 1004 to the user system 32. For example, the CP 34 may reply with a “SessionSetupRes” message, providing a unique SessionID, an electric vehicle supply equipment ID (EVSEID (i.e., the CP ID)), and the supply equipment communication controller (SECC) certificate chain including the CPO (i.e., merchant 12) certificate issuer ID. These steps ensure the EV 24 and CP 34 can authenticate one another via mutual TLS (mTLS) and that subsequent communication remains confidential and tamper-resistant.

In some embodiments where the EV 24 or user system 32 is not connected to the Internet, the user system 32 may query the CP 34 to determine which external or value-added services are available (ServiceDiscoveryReq). The user system 32 may receive a ServiceDiscoveryRes from the CP 34 that enumerates possible services, including internet connectivity (Service ID=65). This step is performed for payment flows that rely on external networks, such as when the EV 24 does not have its own direct cellular or network link. This exchange of messages enables the user system 32 to learn specific parameters (e.g., ParameterSetID=4 for HTTPS over port 443) for the service. The user system 32 then requests to activate the service (ServiceSelectionReq). After receiving the confirmation from the CP 34 (ServiceSelectionRes), the user system 32 can securely communicate with external systems over TLS via the CP's internet connection.

In the example embodiment, the user system 32 provides the merchant information 1004 to the digital wallet 40. For example, user system 32 may select an appropriate key for signing the merchant information 1004. The selection may depend on the consumer device cardholder verification method (CDCVM)—for example, if the consumer 22 has authenticated with the user system 32 via a biometric or PIN, the user system 32 may decide which private key to leverage. The user system 32 may compile a payload including its DigitalCardId (see FIG. 6), a timestamp, the EVSEID, and the CPO Cert Issuer ID. The user system 32 may sign the payload with the selected private key and forward it to the digital wallet 40.

It is noted that the user system 32 has a DigitalCardId. During a period prior to initiating the payment transaction for charging an EV 24, the user system 32 may establish a secure session with the server system 30 (i.e., the SRC system), and more particularly, a bind API, to bind the DigitalCardID with the public key of the user system 32. For example, in an embodiment, the user system 32 may call the bind API using the HTTP Method/Endpoint “POST/profiles.” The API call parameters may include, for example, and without limitation: (1) a serviceID; (2) an srcClientID; (3) the DigitalCardID; (4) a device identity; and (5) the public key of the user system 32. The server system 30 may associate the public key with the DigitalCardID. For example, the server system 30 associates (binds) the DigitalCardID with the public key in a binding database (not shown). The record or database entry ensures that subsequent charging or authentication attempts signed by the public key will resolve to the specified DigitalCardID for billing and/or identity purposes.

Referring back to FIG. 10, the digital wallet 40 initiates communication with the server system 30 via API 1006. The digital wallet 40 provides the merchant information 1004 and signature to the server system 30 of the interchange network 16 via the API 1006. The server system 30 verifies the merchant information 1004. Such verification includes verifying that the EVSEID and CPO Cert Issuer ID correspond to recognized IDs in the system (DPA_ID and SRCIP_ID), fetching the EV's public key based on the DigitalCardId, and confirming the authenticity of the signature. Verifying the information may include querying the database 26.

After verifying the information 1004, the server system 30 may retrieve the associated payment credentials, such as the Primary Account Number (PAN) and other necessary card details, or generate a payment token and cryptogram for the transaction. The server system 30 then generates a payload, including the payment credentials (i.e., the PAN, token, or cryptogram) and other merchant data. The server system 30 may send the payload to the acquirer 14. The acquirer 14 may validate the payload and send an authorization request 1007 to the interchange network 16. The authorization request 1007 may include the payload. The interchange network 16 may generate transaction information 1008 based on the authorization request 1007. The transaction information 1008 may include the payload. The interchange network 16 sends the transaction information 1008 to the issuer 18.

The issuer 18 processes the transaction information 1008 to pre-authorize a payment amount included in the transaction information 1008. The issuer 18 parses the transaction information 1008 to identify a PAN associated with the payment account of the consumer 22. The issuer 18 subsequently determines whether the payment account includes sufficient available funds for processing the transaction. If the payment account includes sufficient funds to complete the transaction, the issuer 18 determines that pre-authorization is successful and sends a pre-authorization success message to the interchange network 16. Otherwise, the issuer 18 determines that the pre-authorization has failed and sends a pre-authorization failure message to the interchange network 16. Upon receiving the pre-authorization success message, the interchange network 16 sends a message 1009 to the acquirer 14 indicating that the pre-authorization was successful. The acquirer 14 sends a message 1010 to the merchant 12. The message 1010 includes the unique identifier of the CP 34 and an indication of whether the pre-authorization was successful.

Upon receiving the pre-authorization failure message, the interchange network 16 sends a failure message to user system 32 indicating that the pre-authorization was not successful. Upon receiving the failure message, the consumer 22 may select a different payment method stored in the digital wallet 40 and re-submit the transaction information 1008, including information identifying the different payment method.

The user system 32 sends an authorization request 1011 to the CP 34, which prompts the CP 34 to ask the merchant 12 for an updated authorization status message 1014. Upon receiving an “OK” message 1014 from the merchant 12, the CP 34 returns an authorization response “OK” message 1016 to the EV 24, confirming that the charging session may proceed. This asynchronous loop may be required due to the potential latency in online payment authorization, ensuring that the EV 24 only commences charging after the CP 34 has retrieved the payment authorization result from the interchange network 16. After charging is completed, the CP 34 sends a report to the merchant 12, indicating a final amount to charge the payment account of the consumer 22.

### Computer-Implemented Methods for Ev Charging Payment Transaction

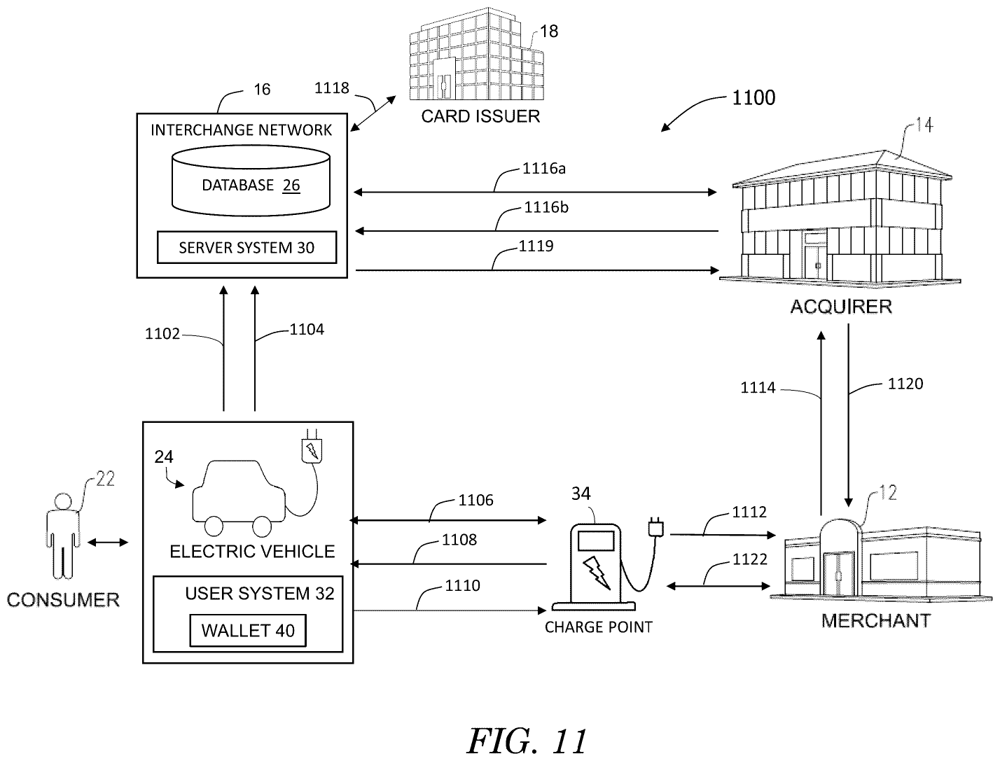

FIG. 11 is a schematic diagram of the system 10 showing an alternative data flow 1100 among the parties during a payment transaction for charging an EV. In this alternative embodiment, the payment transaction is a card-not-present transaction where the consumer 22 initiates the payment transaction using, for example, and without limitation, account information stored in the digital wallet 40 of the user system 32 to provide payment information associated with a cost of charging the EV 24.

In the example embodiment, the user system 32 retrieves payment account information 1102, such as a PAN or DigitalCardID, from the digital wallet 40. The payment account information 1102 is sent to the server system 30 of the interchange network 16 to initiate a registration process for registering the payment information 1102 with the interchange network 16. The server system 30 processes the payment information 1102 and stores a profile of the consumer 22, including the payment information 1102, in the database 26. The user system 32 generates a public/private key pair (i.e., and asymmetric key pair) associated with an EV unique identifier (ID) of the EV 24. In the example embodiment, the unique identifier of the EV 24 may be a vehicle identification number (VIN). The private key is stored in the digital wallet 40. The digital wallet 40 binds the public key to the EV unique ID and DigitalCardID to generate a bound EV ID 1104. The bound EV ID 1104 is sent to the server system 30. The server system 30 stores the bound EV ID 1104 in the profile of the consumer 22 in the database 26 to complete the registration process.

In the example embodiment, the CP 34 includes a merchant computer device (not shown), such as the computing system 330 (shown in FIG. 3). To initiate the EV charging process, the consumer 22 connects an electrical connector of the EV 24 (e.g. electrical connector 220 shown in FIG. 2) with an electrical connector of the CP 34 (e.g. electrical connector 320 shown in FIG. 3) to exchange handshaking information 1106 as part of a handshaking procedure for establishing communication between the EV 24 and the CP 34. It is noted that the messages between the EV 24 and the CP 34, may, in at least some instances, conform to the International Organization for Standardization (ISO) Standard 15118, vehicle to grid communication interface, which is the ISO standard for systems that exchange electronic messages between an electric vehicle and an electric grid. In the example embodiment, the handshaking information 1106 can be a plurality of ISO 15118 type messages.

After communication is established between the CP 34 and the EV 24, the CP 34 transmits merchant information 1108 to the EV 24. The merchant information 1108 includes a unique identifier of the CP 34, a unique identifier of the merchant 12, and other merchant information such as an estimated cost of charging the EV 24 and a timestamp. The user system 32 provides the merchant information 1108 to the digital wallet 40. The digital wallet 40 signs the merchant information 1110 with the private key of the public/private key pair to generate signed merchant information 1110 that includes the EV ID 1104. The digital wallet 40 provides the signed merchant information 1110 to the CP 34.

In response to receiving the signed merchant information 1110, the CP 34 sends a charge request 1112, including the signed merchant information 1110, to the merchant 12. At 1114, the merchant 12 forwards the charge request 1112 to the acquirer 14. The acquirer 14 initiates a communication session with interchange API 1116 to authorize the charge request 1112 with the server system 30. The acquirer 14 forwards the charge request 1112 to the server system 30 via the interchange API 1116a.

The server system 30 decrypts and verifies the unique IDs for the CP 34, the EV 24, and the merchant 12. Verifying the unique IDs may include querying the database 26 and determining whether any stored IDs match the unique identifiers of the CP 34 and the merchant 12. In response to verifying the unique IDs, the server system 30 retrieves a DigitalCardID (e.g. the DigitalCardID described in reference to FIG. 6) from the database 26. The DigitalCardID is associated with a payment card registered with the server system 30.

After retrieving the DigitalCardID, the server system 30 generates a payload. The payload may include the DigitalCardID; the unique IDs of the CP 34, the merchant 12, and the EV; and other merchant data. The server system 30 may send the payload to the acquirer 14 via the API 1116a. The acquirer 14 may validate the payload and send an authentication request 1116b to the server 30. The authentication request 1116b may include the payload. The server system 30 verifies the unique IDs of the EV, the CP, and the merchant, which are included in the payload of the authentication request 1116b. The server 30 may generate transaction information 1118 based on the authorization request 1116b. The transaction information 1118 may include the payload. The server system 30 sends the transaction information 1118 to the issuer 18.

The issuer 18 processes the transaction information 1118 to pre-authorize a payment amount included in the transaction information. The issuer 18 parses the transaction information 1118 to identify a PAN associated with the payment account of the consumer 22. The issuer 18 subsequently determines whether the payment account includes sufficient available funds for processing the transaction. If the payment account includes sufficient funds to complete the transaction, the issuer 18 determines that pre-authorization is successful and sends a pre-authorization success message to the server system. Otherwise, the issuer 18 determines that the pre-authorization has failed and sends a pre-authorization failure message to the server system 30. Upon receiving the pre-authorization success message, the server system 30 sends a message 1119 to the acquirer 14 indicating that the pre-authorization was successful. The acquirer 14 sends a message 1120 to the merchant 12. The message 1120 includes the unique ID of the CP 34 and an indication of whether the pre-authorization was successful.

Upon receiving the pre-authorization failure message, the server system 30 sends a failure message to user system 32 indicating that the pre-authorization was not successful. Upon receiving the failure message, the consumer 22 may select a different payment method stored in the digital wallet 40 and re-submit the transaction information 1118, including information identifying the different payment method.

If the message 1120 received by the merchant 12 indicates that pre-authorization was successful, the merchant 12 sends an instruction 1122 to the CP 34 to begin charging the EV 24. After charging is completed, the CP 34 sends a report to the merchant 12 indicating a final amount to charge the payment account of the consumer 22.

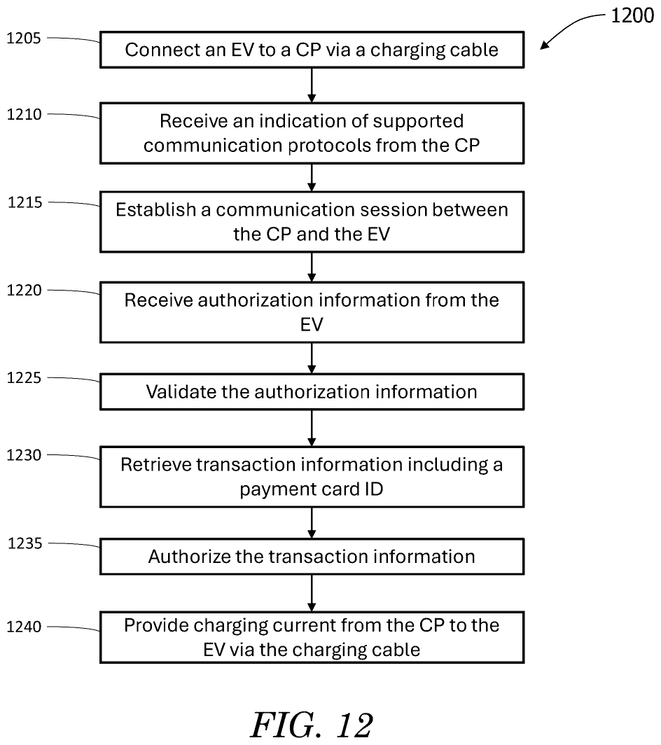

FIG. 12 is a process flow diagram of a method 1200 for charging an electric vehicle (e.g. the EV 24 shown in FIG. 1). At step 1205 the EV is connected to a CP (e.g. the CP 34 shown in FIG. 1) via a charging cable (e.g. charging cable 310 shown in FIG. 3). At step 1210, the EV queries the CP and receives an indication of supported communication protocols from the CP. In one embodiment, the supported communication protocols include various protocols through which payment may be provided. At step 1215, the EV and CP perform a handshaking process (as described in reference to FIGS. 8-10) to establish electronic communication with one another. As part of the handshaking process, the EV provides an EV ID (e.g. the VIN of the EV) to the CP, and the CP provides a CP ID and a merchant ID to the EV. After communication is established, at step 1220, the EV provides authorization information to the CP. The authorization information includes a timestamp, the EV ID, the CP ID, the merchant ID, and other information used for authorization. The authorization information is signed by the EV using a public key (e.g. the public key described in reference to FIG. 7). The CP provides the authorization information to the merchant. The merchant may provide the authorization information to the server system.

At step 1225, the authorization information is validated by the server system. Validating the transaction information by the server system includes parsing the authorization information to identify the EV ID. The server system uses the EV ID to query a database (e.g. the database 26 shown in FIG. 1) for retrieving a public key of the vehicle (e.g. the public key described in reference to FIG. 7). The server system validates the authorization information by decrypting the signed authorization information using the EV public key. At step 1230, the server system may retrieve transaction information in response to validating the authorization information. The server system retrieves a DigitalCardID (e.g. the DigitalCardID described in reference to FIG. 6) from a database (e.g. the database 26 shown in FIG. 1). The DigitalCardID is associated with a payment card registered with the server system. The server system may send the transaction information including the DigitalCardID to the acquirer. The acquirer validates the transaction information and sends the transaction information and an authorization request back to the server system.

At step 1235, the server system authorizes the transaction information and the authorization request received from the acquirer. The server system sends an indication to the merchant that the authorization was successful. In response to receiving the indication, the merchant instructs the CP to begin charging the EV. At step 1240, the CP begins providing a charging current to the EV.

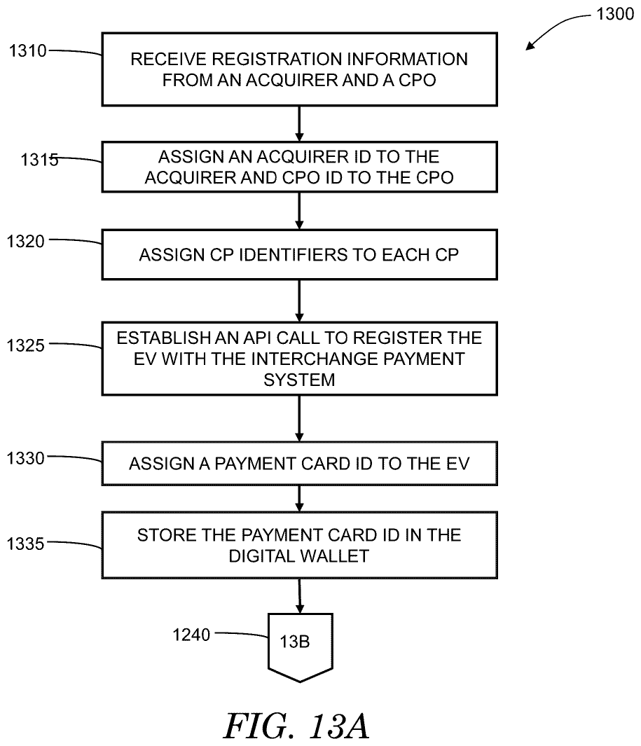

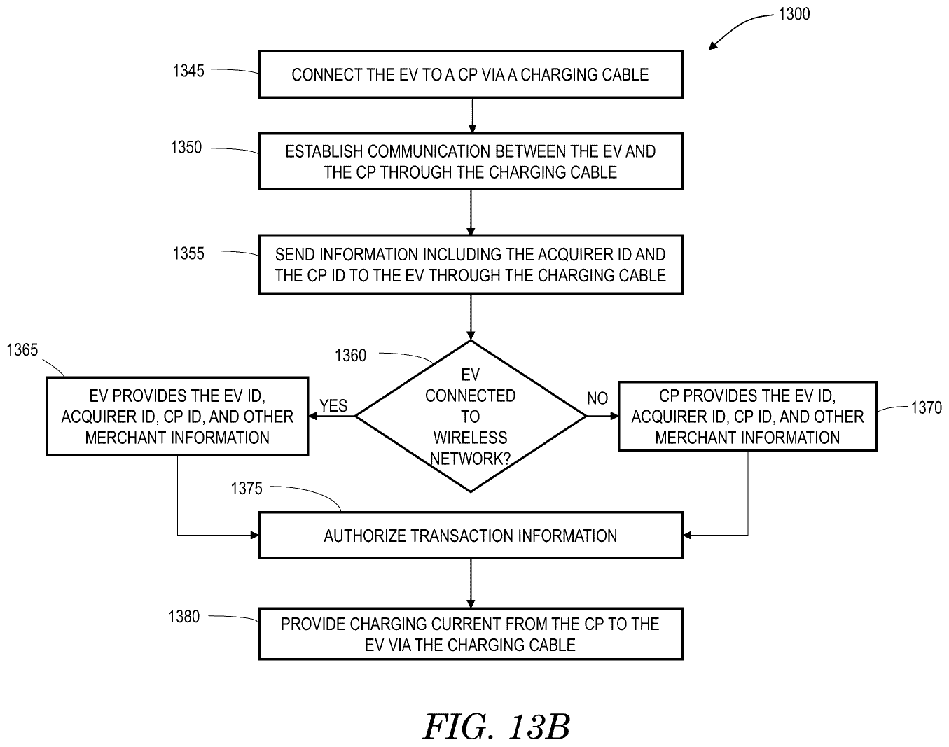

FIGS. 13A and 13B are process flow diagrams of a method 1300 for charging an electric vehicle (e.g. the EV 24 shown in FIG. 1). At step 1310, registration information is received by a server system (e.g. the server system 30 shown in FIG. 1) from an acquirer (e.g. the acquirer 14 shown in FIG. 1) and a CPO (e.g. the merchant 12 shown in FIG. 1). The registration information includes information associated with various entities to be registered with the server system, including one or more CPs (e.g. the CPs 34 shown in FIG. 1) and one or more CPOs. At step 1315, the server system 30 processes the registration information and assigns respective unique acquirer identifiers (ID) to the acquirer and the CPO. At step 1320, the server system 30 assigns respective unique CP IDs to each of the one or more CPs.

At step 1325, a call is established with an API (e.g. the API 906 shown in FIG. 9), to register one or more EVs (e.g. the EV 24 shown in FIG. 1) with the server system 30. The EV may send a unique EV ID to the server system as part of the registration process. At step 1330, the server system assigns a unique DigitalCardID to the EV. At step 1335, the EV stores the DigitalCardID in a digital wallet (e.g. the digital wallet 40 shown in FIG. 1). The DigitalCardID may identify a payment account associated with the user.

In the exemplary embodiment, the unique IDs for the acquirer, the CPO, the one or more CPs, and the one or more EVs may include previously existing IDs provided by the respective entities. For example, the unique EV ID may comprise a VIN associated with the EV In an alternative embodiment, the unique IDs may be generated by the server system using any manner known to one of ordinary skill in the art.

At step 1345, the EV is connected to a CP via a charging cable (e.g. charging cable 310 shown in FIG. 3). At step 1350, the EV and CP perform a handshaking process (as described in reference to FIGS. 9-11) to establish electronic communication with one another. After communication is established, at step 1355, the CP sends merchant information to the EV The merchant information includes the CP ID, the acquirer ID, the CPO ID, and other merchant information.

At step 1360, the CP determines whether the EV is connected to a wireless communication network (e.g. network 20 shown in FIG. 1). If the EV is connected to the wireless network, the method proceeds to step 1365. At step 1365, the EV establishes communication with the API to provide transaction information to the server system. The transaction information includes the EV ID, the acquirer ID, the CP ID, the CPO ID, and the other merchant information. The other merchant information may include a request amount to charge a payment account of the consumer 22 and a timestamp received from the CP 34.

At step 1370, if the EV 24 is not connected to the wireless network, the CP 34 provides an indication to the EV 24 that the CP 34 supports a value-added service (VAS). The VAS provides remote communication capabilities to the EV 24 through the CP 34 by utilizing network connections of the CP 34 to provide the transaction information to the server system.

At step 1375, the server system authorizes the transaction information by validating the EV ID, the acquirer ID, the CP ID, the CPO ID, and the other merchant information. Validating the transaction information by the server system includes parsing the transaction information to identify the EV ID. The server system uses the EV ID to query a database (e.g. the database 26 shown in FIG. 1) for retrieving a public key of the vehicle (e.g. the public key described in reference to FIG. 7). The DigitalCardID is associated with a payment card registered with the server system. The server system may send the transaction information including the DigitalCardID to the acquirer. The acquirer may validate the transaction information and send the transaction information and an authorization request back to the server system.

The server system authorizes the transaction information and the authorization request received from the acquirer. The server system sends an indication to the merchant that the authorization was successful. In response to receiving the indication, the merchant instructs the CP to begin charging the EV As described in FIG. 10, the server system sends an indication that the authorization is successful. At step 1380, the CP begins providing a charging current to the EV.

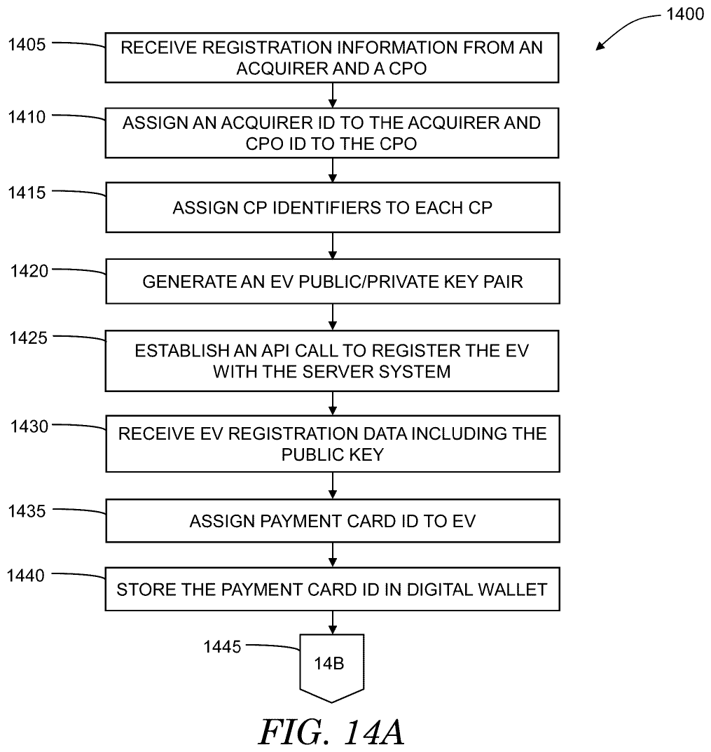

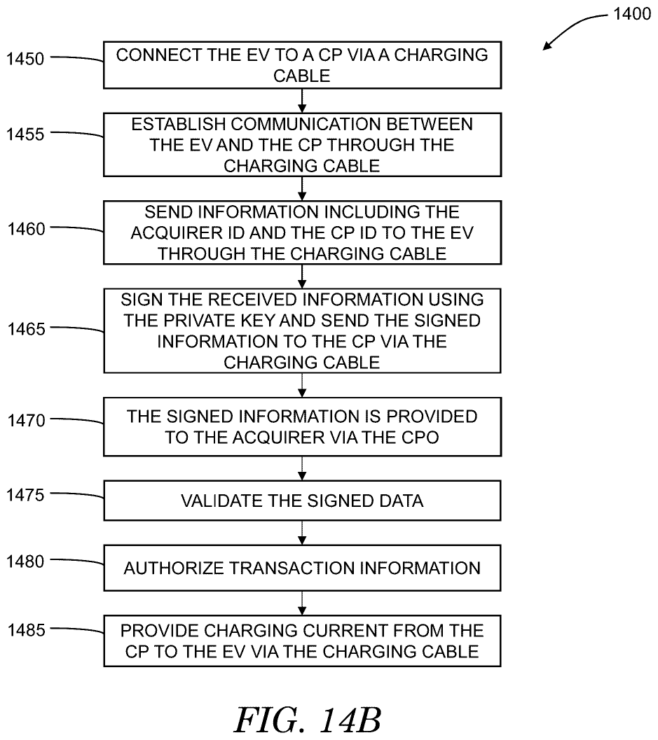

FIGS. 14A and 14B are process flow diagrams of an alternative process 1400 for charging an EV, such as the EV 24 (shown in FIG. 1). At step 1405, registration information is received by a server system (e.g. the server system 30 shown in FIG. 1) from an acquirer (e.g. the acquirer 14 shown in FIG. 1) and a CPO (e.g. the merchant 12 shown in FIG. 1). The registration information includes information associated with various entities to be registered with the server system, including one or more CPs (e.g. the CPs 34 shown in FIG. 1) and one or more CPOs. At step 1410, the server system 30 processes the registration information and assigns respective unique acquirer identifiers (ID) to the acquirer and the CPO. At step 1415, the server system 30 assigns unique CP IDs to each of the one or more charge points.

At step 1420, a digital wallet (e.g. digital wallet 40 shown in FIG. 1) of an EV (e.g. EV 24 shown in FIG. 1) generates a public/private key pair (i.e., an asymmetric key pair) to encrypt information associated with charging the EV. At step 1425, an API call is established to register the EV with the server system. At step 1430, the server system receives registration data from the EV. The registration data includes the public key of the public/private key pair. At step 1435, the server system assigns a unique DigitalCardID to the EV. At step 1440, the DigitalCardID is stored in the digital wallet.

At step 1450, the EV is connected to a CP via a charging cable (e.g. charging cable 310 shown in FIG. 3). At step 1455, the EV and CP perform a handshaking process (as described in reference to FIGS. 9-11) to establish electronic communication with one another. In one embodiment, the CP sends a message to the EV indicating that the CP supports a value-added service (VAS) for retrieving payment information from the server system. The VAS includes instructions for structuring a data packet used to communicate payment information. After communication is established, at step 1460, the CP sends merchant information to the EV. The merchant information includes the CP ID, the acquirer ID, the CPO ID, and other merchant information.

At step 1465, the user system of the EV launches a digital wallet application to access the digital wallet and signs the merchant information using the private key of the public/private key pair. The EV subsequently sends the signed merchant information and the EV ID to the CP. In one embodiment, the EV sends the signed merchant information to the CP by overloading a data packet with payment information used by the server system to retrieve payment account information associated with the user. In an alternative embodiment, the EV sends the signed merchant information to the CP by generating a data packet in accordance with the VAS provided by the CP. At step 1470, the signed merchant information is sent to the acquirer by the CPO associated with the CP. At step 1475, the acquirer sends the signed merchant information to the server system to be validated. The server system validates the signed merchant information by decrypting the signed merchant information using the public key of the EV.

At step 1480, the server system authorizes the transaction information by validating the EV ID, the acquirer ID, the CP ID, the CPO ID, and the other merchant information. Validating the transaction information by the server system includes parsing the transaction information to identify the EV ID. The server system uses the EV ID to query a database (e.g. the database 26 shown in FIG. 1) for retrieving a public key of the vehicle (e.g. the public key described in reference to FIG. 7). The DigitalCardID is associated with a payment card registered with the server system. The server system may send the transaction information including the DigitalCardID to the acquirer. The acquirer may validate the transaction information and send the transaction information and an authorization request back to the server system.

The server system sends the transaction information and the authorization request to an issuer (e.g. the issuer 18, as described in FIG. 7). The issuer may authorize the transaction information and the authorization request. The issuer may send an indication of whether the transaction information and authorization request are successfully authorized. The server system sends an indication to the merchant that the authorization was successful. In response to receiving the indication, the merchant instructs the CP to begin charging the EV. At step 1485, the CP begins providing a charging current to the EV

### Parallel Session Payment Transaction Flow

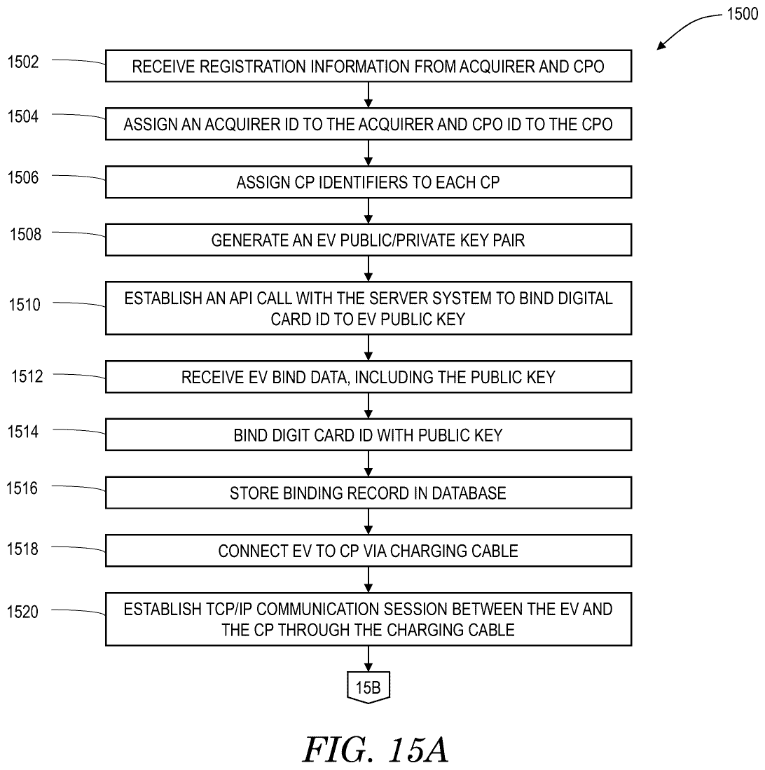

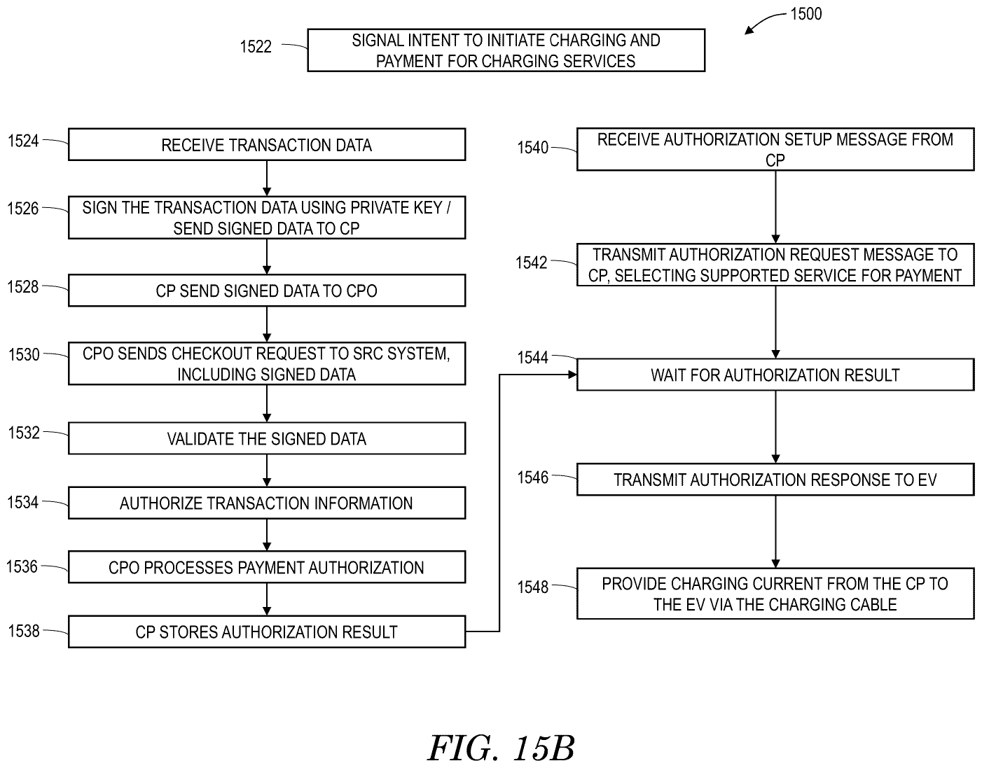

FIGS. 15A and 15B are process flow diagrams of a parallel session process 1500 for charging an EV, such as the EV 24 (shown in FIG. 1). At step 1502, registration information is received by the server system 30 (shown in FIG. 1) from the acquirer 14 (shown in FIG. 1) and the CPO or merchant 12 (shown in FIG. 1). The registration information includes information associated with various entities to be registered with the server system 30, including one or more CPs 34 (shown in FIG. 1). At step 1504, the server system 30 processes the registration information and assigns respective unique acquirer identifiers (IDs) to the acquirer 14 and the merchant 12. At step 1506, the server system 30 assigns unique CP IDs to each of the one or more CPs 34.

At step 1508, one of the user system 32 or digital wallet 40 (shown in FIG. 1) of the EV 24 generates a public/private key pair (i.e., an asymmetric key pair) to encrypt information associated with charging the EV 24. If the digital wallet 40 generates the key pair, the digital wallet 40 securely provisions the private key within the EV (e.g., within the user system 32). If user system 32 generates the key pair, the user system 32 shares the public key with digital wallet 40.

It is noted that the user system 32 or digital wallet 40 has a DigitalCardId stored thereon (described above). At step 1510, the user system 32 may establish a secure session with the server system 30 (i.e., the SRC system), and more particularly, a bind API, to bind the DigitalCardID with the public key of the user system 32. For example, in an embodiment, the user system 32 may call the bind API using the HTTP Method/Endpoint “POST/profiles.” The API call parameters may include, for example, and without limitation: (1) a serviceID; (2) an srcClientID; (3) the DigitalCardID; (4) a device identity; and (5) the public key of the user system 32.

At step 1512, the server system 30 receives the API call and associated data elements from the user system 32. The registration data includes the public key of the public/private key pair and the DigitalCardID. At step 1514, the server system 30 associates (binds) the public key with the DigitalCardID. At step 1516, the server system 30 stores the DigitalCardID-to-public key binding in a database (not shown). The record or database entry ensures that subsequent charging or authentication attempts signed by the public key will resolve to the specified DigitalCardID for billing and/or identity purposes.

At step 1518, the EV 24 is connected to a CP via a charging cable (e.g. charging cable 310 shown in FIG. 3). At step 1520, the EV and CP perform a handshaking process (as described in reference to FIG. 9) to establish electronic communication with each other. In the exemplary embodiment, a transport control protocol/internet protocol (TCP/IP) session is established (e.g., over a TLS-encrypted session). The TCP/IP provides a secure parallel communication session such that transaction information is communicated separately from communication channels used to exchange EV charging information. In one embodiment, the TCP/IP session facilitates communication of ISO 15118 type messages. More specifically, the TCP/IP session may utilize an ISO 15118-20 communication channel for exchanging ISO 15118 type messages.

After secure communication is established between the CP 34 and the EV 24, at step 1522, the EV 24 signals its intent to initiate charging and payment for the charging services. In response, at step 1524, the CP 34 sends transaction information to the EV 24 through the TCP/IP session. The transaction information includes the CP ID, the acquirer ID, the CPO-ID, and other transaction information. More particularly, the CP 34 may provide a list of supported payment services. The EV 24 may select to pay via the DigitalCardID. The CP 34 may then send challenge data to the EV 24.

At step 1526, the user system 32 of the EV 24 launches the digital wallet 40 and signs the transaction information using the private key of the public/private key pair. The EV 24 subsequently sends the signed transaction information and the DigitalCardID to the CP 34. In one embodiment, the EV 24 sends the signed transaction information to the CP 34 by overloading a data packet (IdToken) with payment information used by the server system 30 to retrieve payment account information associated with the user. The signed transaction information may include, for example, the DigitalCardId, a timestamp, the EVSEID, and the CPO Cert Issuer ID (Described herein in reference to FIG. 10).

At step 1528, the CP 34 provides the signed transaction information to the merchant 12. Optionally, the merchant 12 may forward the authentication information 904 to its acquirer 14. In the exemplary embodiment, the merchant 12 or the acquirer 14 (1) extracts the DigitalCardID, (2) extracts the IdToken that includes the signed data from the EV 24, (3) creates a “DpaTransactionOptions” parameter (which might contain details about the transaction amount, pricing, or currency), and (4) creates a checkout request message with these components in the assurance data.

At step 1530, the merchant 12 or acquirer 14 transmits the checkout request message to the server system 30 (i.e., the SRC system). The checkout request message includes the authentication information, the extracted IdToken, and the extracted DigitalCardID. The server system 30 parses the checkout request message to verify the authenticity and integrity of the payload. For example, at step 1532, the server system 30 verifies the merchant information. Verification of the merchant information includes verifying that the EVSEID and CPO Cert Issuer ID correspond to recognized IDs in the system (DPA_ID and SRCIP_ID), fetching the EV's public key based on the DigitalCardId, and confirming the authenticity of the signature.

After validating the data elements received in the checkout request message and determining that the DigitalCardID is validly bound, at step 1534, the server system 30 authorizes the transaction data. In particular, the server system 30 may retrieve the associated payment credentials, such as the Primary Account Number (PAN) and other necessary card details, or generate a payment token and cryptogram for the transaction. The server system 30 may generate a checkout response message. The checkout response message may include the payment credentials (i.e., the PAN, token, or cryptogram) and a correlationID. The server system 30 may transmit the checkout response message to the merchant 12 or acquirer 14. If the binding validation fails—for example, if the DigitalCardID is expired, revoked, or does not match the EV identity in the contract—the server system 30 declines the request and returns an error or failure status indicating the reason for the mismatch.

In the example embodiment, after receiving the checkout response message, the merchant 12 or acquirer 14 proceeds with processing a payment authorization at step 1536 (as described further herein with respect to FIG. 10). At step 1538, the merchant 12 or acquirer 14 transmits the authorization result to the CP 34 for storage thereon.

Substantially simultaneously or in parallel with step 1524, at step 1540, the CP 34 responds to the intent to initiate charging services message from the EV 24 with an authorization setup message. For example, the CP 34 may reply to the EV 24 with a “AuthorizationSetupRes” message, providing a unique Session ID, a list of the supported services (e.g., EIM, PnC) signed with the supply equipment communication controller (SECC) certificate, and the SECC certificate chain including the CPO certificate issuer ID, similarly signed.

At step 1542, the EV 24 may transmit an authorization request message back to the CP 34, referencing the session ID, a timestamp, and specifying the selected authorization service (EIM). At step 1544, the CP 34 checks for the authorization result (described above in step 1538). Notably, the CP 34 waits until a positive authorization result is provided by the merchant 12 before proceeding with charging of the EV 24.

After receiving a positive authorization result, at step 1546, the CP 34 transmits an authorization response message to the EV 24, indicating the authorization was successful. As noted herein, in an embodiment using ISO 15118-20, the CP 34 may send an “AuthorizationRes” message, typically containing (1) a “ResponseCode” (e.g., accepted or rejected), (2) an “EVSEProcessing” parameter that indicates whether the EV 24 can immediately start charging or if the CP 34 requires more time to finalize setup, and (3) the Session ID, making the session reference explicit while still conveying the outcome and next steps for charging. At step 1548, the CP 34 provides charging current to the EV 24 via the charging cable 310. It is noted that steps 1524-1538 are performed substantially in parallel with steps 1540-1544 of this parallel session process 1500.

### Computer-Implemented Method for Charging an EV

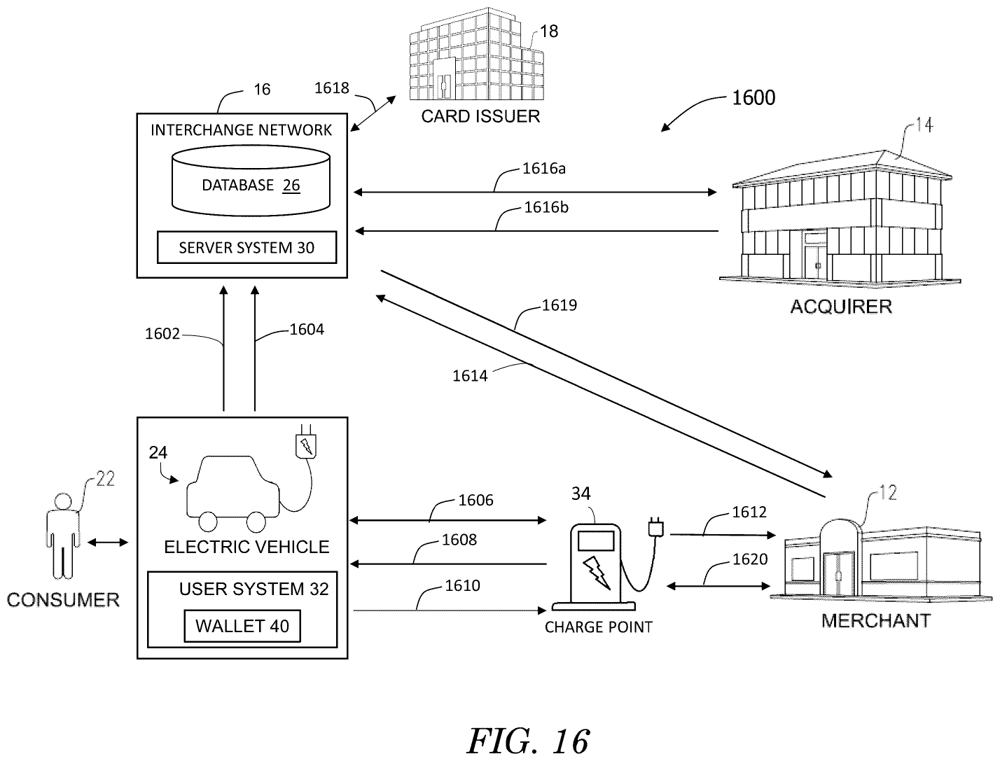

FIG. 16 is a schematic diagram of the system 10 showing a data flow 1600 among the parties during a payment transaction for charging an EV. In this alternative embodiment, the payment transaction is a card-not-present transaction where the consumer 22 initiates the payment transaction using, for example, and without limitation, account information stored in the digital wallet 40 of the user system 32 to provide payment information associated with a cost of charging the EV 24.

In the example embodiment, the user system 32 retrieves payment account information 1602, such as a PAN or DigitalCardID, from the digital wallet 40. The payment account information 1602 is sent to the server system 30 of the interchange network 16 to initiate a registration process for registering the payment information 1602 with the interchange network 16. The server system 30 processes the payment information 1602 and stores a profile of the consumer 22, including the payment information 1602, in the database 26. The user system 32 generates a public/private key pair associated with an EV unique identifier (ID) of the EV 24. In the example embodiment, the unique identifier of the EV 24 may be a vehicle identification number (VIN). The private key is stored in the digital wallet 40. The digital wallet 40 binds the public key to the EV unique ID and DigitalCardID to generate a bound EV ID 1604. The bound EV ID 1604 is sent to the server system 30. The server system 30 stores the bound EV ID 1604 in the profile of the consumer 22 in the database 26 to complete the registration process.

In the example embodiment, the CP 34 includes a merchant computer device (not shown), such as the computing system 330 (shown in FIG. 3). To initiate the EV charging process, the consumer 22 connects an electrical connector of the EV 24 (e.g. electrical connector 220 shown in FIG. 2) with an electrical connector of the CP 34 (e.g. electrical connector 320 shown in FIG. 3) to exchange handshaking information 1606 as part of a handshaking procedure for establishing communication between the EV 24 and the CP 34. It is noted that the messages between the EV 24 and the CP 34, may, in at least some instances, conform to the International Organization for Standardization (ISO) Standard 15118, vehicle to grid communication interface, which is the ISO standard for systems that exchange electronic messages between an electric vehicle and an electric grid. In the example embodiment, the handshaking information 1606 can be a plurality of ISO 15118 type messages.

After communication is established between the CP 34 and the EV 24, the CP 34 transmits merchant information 1608 to the EV 24. The merchant information 1608 includes a unique identifier of the CP 34, a unique identifier of the merchant 12, and other merchant information such as an estimated cost of charging the EV 24 and a timestamp. The user system 32 provides the merchant information 1608 to the digital wallet 40. The digital wallet 40 signs the merchant information 1610 with the private key of the public/private key pair to generate signed merchant information 1610 that includes the EV ID 1604. The digital wallet 40 provides the signed merchant information 1610 to the CP 34.

In response to receiving the signed merchant information 1610, the CP 34 sends a charge request 1612, including the signed merchant information 1610, to the merchant 12. At 1614, the merchant 12 forwards the charge request 1612 to the server system 30. The server system 30 initiates a communication session with interchange API 1616 to authorize the charge request 1612 with the acquirer 14. The acquirer 14 forwards the charge request 1612 to the server system 30 via the interchange API 1616a.

The server system 30 decrypts and verifies the unique IDs for the CP 34, the EV 24, and the merchant 12. Verifying the unique IDs may include querying the database 26 and determining whether any stored IDs match the unique identifiers of the CP 34 and the merchant 12. In response to verifying the unique IDs, the server system 30 retrieves a DigitalCardID (e.g. the DigitalCardID described in reference to FIG. 6) from the database 26. The DigitalCardID is associated with a payment card registered with the server system 30.

After retrieving the DigitalCardID, the server system 30 generates a payload. The payload may include the DigitalCardID; the unique IDs of the CP 34, the merchant 12, and the EV; and other merchant data. The server system 30 may send the payload to the acquirer 14 via the API 1616a. The acquirer 14 may validate the payload and send an authentication request 1616b to the server 30. The authentication request 1616b may include the payload. The server system 30 verifies the unique IDs of the EV, the CP, and the merchant, which are included in the payload of the authentication request 1616b. The server 30 may generate transaction information 1618 based on the authorization request 1616b. The transaction information 1618 may include the payload. The server system 30 sends the transaction information 1618 to the issuer 18.

The issuer 18 processes the transaction information 1618 to pre-authorize a payment amount included in the transaction information. The issuer 18 parses the transaction information 1618 to identify a PAN associated with the payment account of the consumer 22. The issuer 18 subsequently determines whether the payment account includes sufficient available funds for processing the transaction. If the payment account includes sufficient funds to complete the transaction, the issuer 18 determines that pre-authorization is successful and sends a pre-authorization success message to the server system. Otherwise, the issuer 18 determines that the pre-authorization has failed and sends a pre-authorization failure message to the server system 30. Upon receiving the pre-authorization success message, the server system 30 sends a message 1619 to the merchant 12 indicating that the pre-authorization was successful. The message may include an encrypted payload including payment information for charging the EV.

Upon receiving the pre-authorization failure message, the server system 30 sends a failure message to user system 32 indicating that the pre-authorization was not successful. Upon receiving the failure message, the consumer 22 may select a different payment method stored in the digital wallet 40 and re-submit the transaction information 1618, including information identifying the different payment method.

The merchant 12 may decrypt the payload. In an example, the payload may be encrypted with a public key of the merchant 12. The merchant 12 may decrypt the payload using a private key of the merchant 12. In another example, the payload may be encrypted with a private key of the acquirer 14. The merchant 12 may send the payload to the acquirer 14 such that the acquirer may decrypt the payload using a public key of the acquirer 14. Alternatively, the merchant 12 may have access to the public key of the acquirer 14 and may decrypt the payload using the public key of the acquirer 14. In another example, the acquirer 14 may receive a correlation ID instead of the payload. The merchant 12 may query an API of the server system 30 to retrieve the payload. In this example, the payload may be encrypted with the private key of the merchant 12 or the private key of the acquirer 14.

If the message 1619 received by the merchant 12 indicates that pre-authorization was successful, the merchant 12 sends an instruction 1620 to the CP 34 to begin charging the EV 24. After charging is completed, the CP 34 sends a report to the merchant 12 indicating a final amount to charge the payment account of the consumer 22.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A computer-implemented method for enabling a secure remote commerce (SRC) transaction for charging an electric vehicle (EV) at a charging point (CP), the method comprising:
establishing, by a user system of the EV, a mutually authenticated and encrypted communication session with the CP via a transport layer security (TLS) protocol;
receiving, by the user system, merchant information from the CP, the merchant information including a unique identifier (ID) of the CP and a charge point operator certificate issuer identifier;
retrieving, by the user system, payment credentials from a digital wallet stored in the EV, the payment credentials comprising a digital card ID assigned to the EV by an SRC system;
generating, by the user system, a cryptographically signed payload comprising the digital card ID, the merchant information, and a timestamp, the signed payload being signed by the user system using a private key associated with the EV;
transmitting, by the user system, the signed payload to the SRC system via an application programming interface (API) over a secure communication channel;
receiving, by the user system, an authorization response from the CP, the authorization response indicating that the payment transaction is approved; and
in response to receiving an authorization approval, transmitting, by the user system, a command to the CP to initiate charging of the EV.

2. The method of claim 1, further comprising:
binding the digital card ID to a public key associated with the EV via a binding API before initiating the transaction.

3. The method of claim 1,
the operation of generating the cryptographically signed payload comprises applying a digital signature using an asymmetric key pair.

4. The method of claim 1, further comprising:
monitoring for a payment authorization response via the CP, and
upon receiving a positive payment authorization response, permitting the CP to deliver charging power to the EV.

5. The method of claim 1,
the operation of establishing the mutually authenticated and encrypted communication session comprises using mutual TLS (mTLS) authentication, including transmitting, by the user system, a user system digital certificate to the CP and receiving, by the user system, a CP digital certificate.

6. The method of claim 1,
the operation of receiving the merchant information from the CP includes receiving the merchant information as part of an ISO 15118-compliant communication session.

7. The method of claim 1,
the digital card ID comprising a tokenized representation of a primary account number (PAN).

8. The method of claim 1, further comprising:
transmitting, by the user system, an authorization request to the CP, requesting commencement of charging of the EV.

9. The method of claim 1, further comprising:
querying the CP, by the user system, for available network services to facilitate payment processing in the absence of a direct network connection by the EV.

10. The method of claim 1, further comprising:
receiving, by the user system, the digital card ID through a secure enrollment process with the SRC system, the enrollment process including:
establishing, by the user system, a secure API connection with the SRC system over a secure communication channel,
transmitting, by the user system, an enrollment request to the SRC system, the enrollment request including payment card information and user identification data;
receiving, by the user system, an authentication challenge from an issuer associated with the payment card information;
transmitting, by the user system, an authentication input verifying the user's identity in response to the authentication challenge; and
receiving, by the user system, the digital card ID from the SRC system.

11. A computing system for enabling a secure remote commerce (SRC) transaction for charging an electric vehicle (EV) at a charging point (CP), the system comprising:
one or more processors; and
a memory having computer-executable instructions stored thereon, that when executed by the one or more processors, cause the one or more processors to perform operations of:
establishing a mutually authenticated and encrypted communication session with the CP via a transport layer security (TLS) protocol;
receiving merchant information from the CP, the merchant information including a unique identifier (ID) of the CP and a charge point operator certificate issuer identifier;
retrieving payment credentials from a digital wallet stored in the EV, the payment credentials comprising a digital card ID assigned to the EV by an SRC system;
generating a cryptographically signed payload comprising the digital card ID, the merchant information, and a timestamp, the signed payload being signed by using a private key associated with the EV;
transmitting the signed payload to the SRC system via an application programming interface (API) over a secure communication channel;
receiving an authorization response from the CP, the authorization response indicating that the payment transaction is approved; and
in response to receiving an authorization approval, transmitting a command to the CP to initiate charging of the EV.

12. The system of claim 11,
the computer-executable instructions further cause the one or more processors to perform an operation of binding the digital card ID to a public key associated with the EV via a binding API before initiating the transaction.

13. The system of claim 11,
the operation of generating the cryptographically signed payload comprises applying a digital signature using an asymmetric key pair.

14. The system of claim 11, further comprising:
the computer-executable instructions further cause the one or more processors to perform operations of:
monitoring for a payment authorization response via the CP, and
upon receiving a positive payment authorization response, permitting the CP to deliver charging power to the EV.

15. The system of claim 11,
the operation of establishing the mutually authenticated and encrypted communication session comprises using mutual TLS (mTLS) authentication, including transmitting a user system digital certificate to the CP and receiving, by the user system, a CP digital certificate.

16. The system of claim 11,
the operation of receiving the merchant information from the CP includes receiving the merchant information as part of an ISO 15118-compliant communication session.

17. The system of claim 11,
the digital card ID comprising a tokenized representation of a primary account number (PAN).

18. The system of claim 11,
the computer-executable instructions further cause the one or more processors to perform an operation of transmitting an authorization request to the CP, requesting commencement of charging of the EV.

19. The system of claim 11,
the computer-executable instructions further cause the one or more processors to perform an operation of querying the CP for available network services to facilitate payment processing in the absence of a direct network connection by the EV.

20. The system of claim 11,
the computer-executable instructions further cause the one or more processors to perform an operation of receiving the digital card ID through a secure enrollment process with the SRC system, the enrollment process including:
establishing a secure API connection with the SRC system over a secure communication channel,
transmitting an enrollment request to the SRC system, the enrollment request including payment card information and user identification data;
receiving an authentication challenge from an issuer associated with the payment card information;
transmitting an authentication input verifying the user's identity in response to the authentication challenge; and
receiving the digital card ID from the SRC system.
